(19) United States
(12) Patent Application Publication
(10) Pub. No.: US 2025/0178340 A1
(43) Pub. Date: Jun. 5, 2025

(54) INKJET PRINTING APPARATUS, INKJET PRINTING METHOD, AND INKJET PRINTING SYSTEM

(71) Applicant: CANON KABUSHIKI KAISHA, Tokyo (JP)

(72) Inventors: HIDEHIKO KANDA, Kanagawa (JP); TAICHI YOKOKAWA, Kanagawa (JP); YUJI KONNO, Kanagawa (JP); TAKESHI YAZAWA, Kanagawa (JP); MASAKI NITTA, Kanagawa (JP); TAKAYUKI USHIYAMA, Chiba (JP); JUMPEI JOGO, Tokyo (JP)

(21) Appl. No.: 18/968,466

(22) Filed: Dec. 4, 2024

(30) Foreign Application Priority Data
Dec. 5, 2023 (JP) 2023-205142

(51) Int. Cl. B41J 2/045; B41J 2/21; B41M 5/00; B41M 7/00

(52) U.S. Cl. CPC B41J 2/04535; B41J 2/2114; B41J 2/2132; B41M 5/0023; B41M 5/0047; B41M 7/0018; B41M 7/009; B41J 2/0458

(57) ABSTRACT

An inkjet printing apparatus includes a print head to print an image by ejecting a colorant-containing colored ink and a colorant-coagulation reaction liquid onto a print medium, a printer unit to cause the print head to print test patterns on the print medium by correspondingly printing first pattern images with a predetermined volume of the colored ink and second pattern images with different volumes of the reaction liquid, a dryer unit to dry the test patterns on the print medium during printing of the test patterns on the print medium under control of the printer unit, an obtaining unit to obtain print information concerning print results of the test patterns, and a determination unit to determine a volume of the reaction liquid and a drying condition for the dryer unit for printing on the print medium based on the print information obtained by the obtaining unit.

### BACKGROUND

### Field

The present disclosure relates to an inkjet printing apparatus, an inkjet printing method, and an inkjet printing system and relates to a technique for preventing ink bleeding on a print medium by using a reaction liquid.

### Description of the Related Art

An inkjet printing apparatus of this type ejects inks and a reaction liquid together onto a print medium and brings the reaction liquid into contact with the inks on the print medium, thereby coagulating colorants in the inks. Such coagulation of the colorants keeps the inks from bleeding on a print medium, and can be expected to improve the print quality. Regarding this technique, Japanese Patent Laid-Open No. 2018-149735 (Document 1) describes use of a reaction liquid for printing on a print medium having low ink penetration (absorbency). With this, even on a print medium having such low ink absorbency as to allow inks to bleed easily, it is possible to achieve high-quality printing by keeping the inks from bleeding.

In addition, particularly for printing on a print medium having low ink absorbency, a conventional technique of drying a printed area to fix a printed image has been used.

However, in some cases, the bleeding prevention and fixation improvement cannot be adequately achieved only by controlling the application of the reaction liquid as disclosed in Document 1 and controlling the drying conditions. Specifically, a suitable reaction liquid volume and suitable drying conditions vary depending on the wettability of a print medium for use. For example, even a print medium having low absorbency is classified into easily-wettable print media or hardly-wettable print media depending on a surface energy state of the print medium. This surface energy state of a print medium varies depending on, for example, processing conditions of the print medium or the like. Thus, even if print media have similar levels of absorbency, the print media have different levels of wettability, which results in a difference in a combination of the suitable reaction liquid volume and the suitable drying conditions.

### SUMMARY

An inkjet printing apparatus of the present disclosure includes: a print head configured to print an image by ejecting, onto a print medium, a colored ink containing a colorant and a reaction liquid to come into contact with the colorant and coagulate the colorant; a printer unit configured to cause the print head to print a plurality of test patterns composed of a plurality of first image patterns and a plurality of accompanying second pattern images on the print medium by correspondingly printing the first pattern images with a predetermined volume of the colored ink and the second pattern images with respectively different volumes of the reaction liquid; a dryer unit configured to dry the plurality of test patterns on the print medium during printing of the plurality of test patterns on the print medium under control of the printer unit; an obtaining unit configured to obtain print information corresponding to print results of the plurality of respective test patterns; and a determination unit configured to determine a volume of the reaction liquid and a drying condition for the dryer unit for printing on the print medium based on the print information obtained by the obtaining unit.

Further features of the present disclosure will become apparent from the following description of exemplary embodiments with reference to the attached drawings.

### BRIEF DESCRIPTION OF THE DRAWINGS

FIG. 1 is a perspective view schematically illustrating an inkjet printing apparatus according to a first embodiment of the present disclosure;

FIG. 2 is a schematic view illustrating a schematic structure of the inkjet printing apparatus according to the first embodiment of the present disclosure;

FIG. 3 is a view schematically illustrating ejection orifice arrays on a print head according to the first embodiment of the present disclosure;

FIG. 4 is a block diagram illustrating a control configuration of the inkjet printing apparatus according to the first embodiment of the present disclosure;

FIG. 5 is a view schematically illustrating multi-pass printing control according to the first embodiment of the present disclosure;

FIGS. 6A to 6D are schematic diagrams for explaining mask patterns according to the first embodiment of the present disclosure;

FIG. 7 is a schematic diagram illustrating a UI for print medium selection according to the first embodiment of the present disclosure;

FIGS. 8A to 8C are diagrams for explaining quantification of “wettability” of a print medium according to the first embodiment of the present disclosure; FIG. 8A illustrates an example of parameters for determining a contact angle θ, which is an angle between the tangent of a droplet and a solid surface; FIG. 8B is a diagram illustrating a print medium P having an easily wettable property; FIG. 8C is a diagram illustrating a print medium P having a hardly wettable property;

FIG. 9 is a diagram for explaining print medium classification depending on the “absorbency” and “wettability” of a print medium;

FIG. 10 is a diagram for explaining drying conditions according to the first embodiment of the present disclosure;

FIG. 11 is a diagram for explaining test patterns according to the first embodiment of the present disclosure;

FIG. 12 is a view presenting print results of the test patterns on a print medium having a hardly wettable property under first drying conditions according to the first embodiment of the present disclosure;

FIG. 13 is a view presenting print results of the test patterns on a print medium having an easily wettable property under the first drying conditions according to the first embodiment of the present disclosure;

FIG. 14 is a view presenting print results of the test patterns on a print medium having an easily wettable property with air blowing according to the first embodiment of the present disclosure;

FIG. 15 is a flowchart presenting processing for determining drying conditions and a reaction liquid volume for printing according to the first embodiment of the present disclosure;

FIG. 16 is a flowchart presenting a first modification of the processing for determining the drying conditions and the reaction liquid volume for printing according to the first embodiment of the present disclosure;

FIG. 17 is a flowchart presenting a second modification of the processing for determining the drying conditions and the reaction liquid volume for printing according to the first embodiment of the present disclosure;

FIG. 18 is a flowchart presenting processing for determining drying conditions and a reaction liquid volume for printing according to a second embodiment of the present disclosure;

FIG. 19 is a diagram for explaining test patterns according to a third embodiment of the present disclosure;

FIG. 20 is a view presenting print results of the test patterns on a print medium having a hardly wettable property under the first drying conditions according to the third embodiment of the present disclosure;

FIG. 21 is a view presenting print results of the test patterns on a print medium having an easily wettable property under the first drying conditions according to the third embodiment of the present disclosure;

FIG. 22 is a view presenting print results of the test patterns on a print medium having an easily wettable property under second drying conditions according to the third embodiment of the present disclosure; and

FIG. 23 is a diagram for explaining other test patterns according to the third embodiment of the present disclosure.

### DESCRIPTION OF THE EMBODIMENTS

Hereinafter, preferred embodiments of the present disclosure will be described in detail in reference to the accompanying drawings. The following embodiments are not intended to limit the matters disclosed herein. In addition, all the combinations of features described in the following embodiments are not necessarily essential for the solution of the present disclosure. Here, the same constituent elements will be designated with the same reference sign.

### First Embodiment

Description will be given of a first embodiment of the present disclosure capable of obtaining a high-quality image by controlling a dryer unit according to wettability.

### <Printing Apparatus Structure>

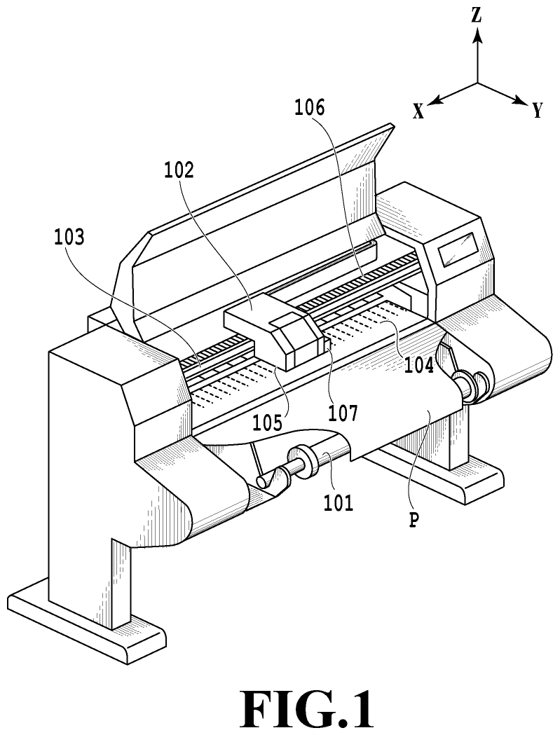

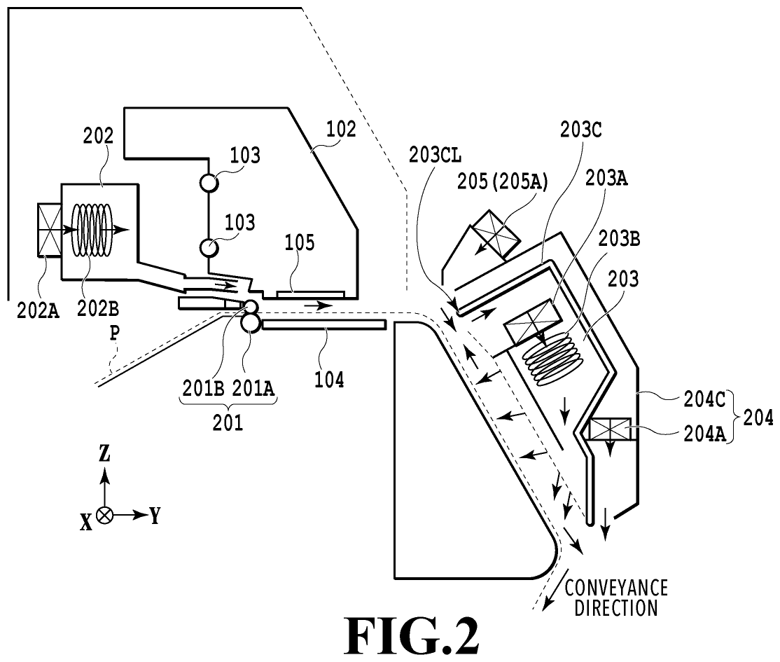

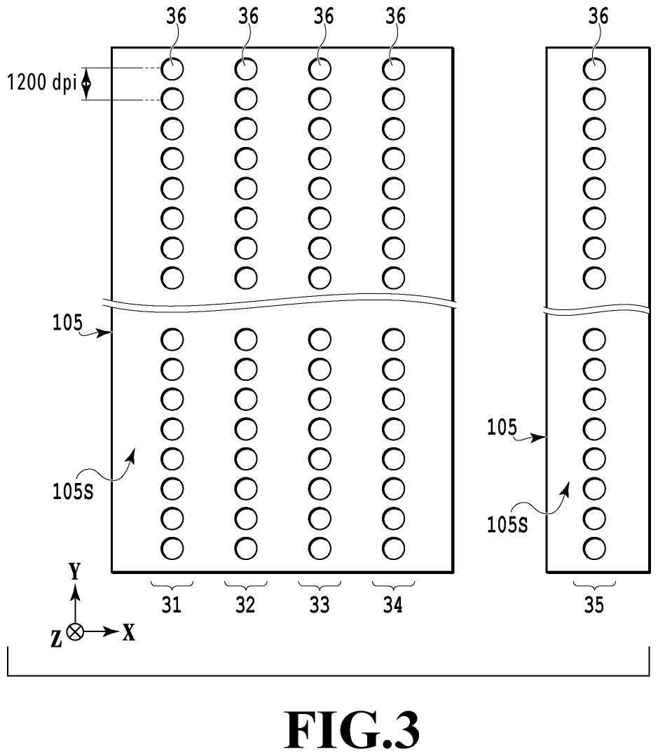

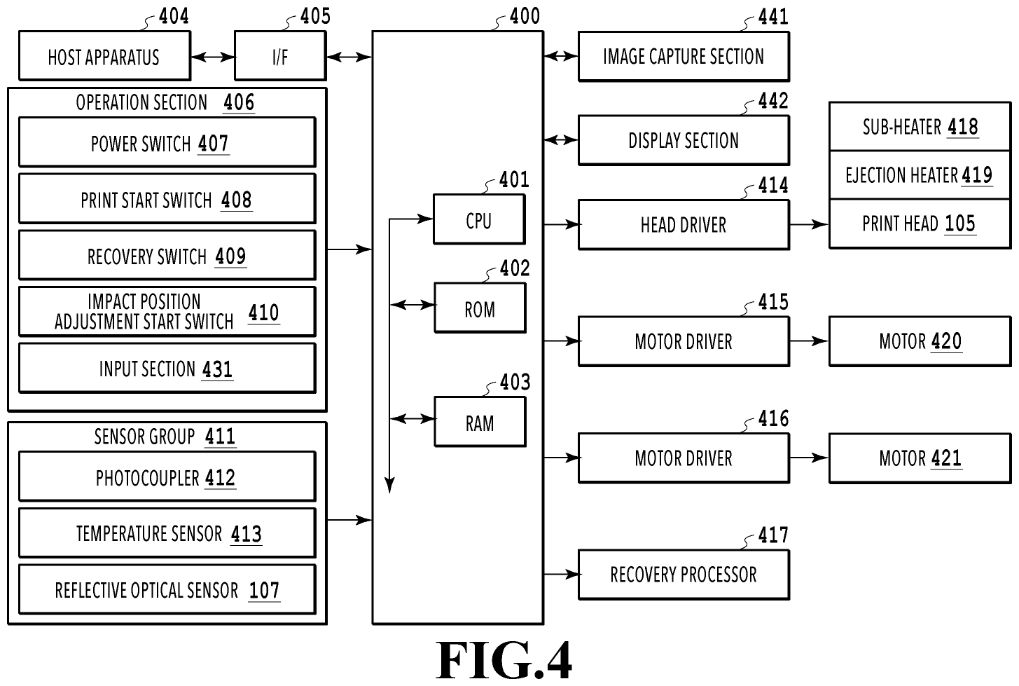

FIG. 1 is a perspective view schematically illustrating an external appearance structure of an inkjet printing apparatus according to a first embodiment of the present disclosure (hereinafter also simply referred to as the “printing apparatus”). FIG. 2 is a schematic view illustrating a schematic structure of the inkjet printing apparatus in FIG. 1 according to the first embodiment of the present disclosure. FIG. 3 is a schematic view illustrating ejection orifice arrays on a print head 105 in FIGS. 1 and 2 according to the first embodiment of the present disclosure. FIG. 4 is a block diagram illustrating a control configuration of the inkjet printing apparatus according to the first embodiment of the present disclosure. In FIGS. 1 and 2, XYZ coordinate axes are illustrated as respective arrows. The Y axis indicates a conveyance direction of a print medium P being conveyed. The print medium Pis conveyed in the direction pointed by the Y-axis arrow. The X axis indicates a scanning direction of a carriage unit 102 (print head 105). The scanning is performed in the direction pointed by the X-axis arrow. In the case of reciprocating printing, the scanning is performed in the direction pointed by the X-axis arrow and in the direction opposite to the direction pointed by the X-axis arrow. The Z axis indicates a height direction of the printing apparatus.

The inkjet printing apparatus in FIG. 1 is a so-called serial scanning type of printing apparatus. This inkjet printing apparatus prints an image by scanning the print head 105 in the X directions (main scanning directions) orthogonal to the Y direction (conveyance direction). In reference to FIGS. 1 to 4, a structure of the inkjet printing apparatus and its printing operation will be outlined below. First, a conveyance unit 201 in FIG. 2 is driven by a sub-scanning motor 421 in FIG. 4 via a gear (not illustrated). A spool 101 in FIG. 1 conveys the print medium P in the Y direction while the print medium Pis being held by the conveyance unit 201 in FIG. 1. Meanwhile, guide shafts 103 in FIGS. 1 and 2 extend in the X direction so as to allow the carriage unit 102 in FIGS. 1 and 2 to be scanned at a predetermined conveyance position by a main scanning motor 420 in FIG. 4. The carriage unit 102 in FIGS. 1 and 2 is scanned along the guide shafts 103 so as to perform reciprocating scanning (reciprocating movement) along an outward path in the +X direction and a return path in the-X direction. In the process of this scanning, a controller 400 in FIG. 4 synchronizes with a timing based on a position signal obtained by an encoder 106 provided along the main scanning direction. Then, the controller 400 in FIG. 4 causes the print head 105, which is attachable to the carriage unit 102, to perform an ejection operation from its ejection orifices, thereby making a print on the print medium P. In the process of the reciprocating scanning, the controller 400 in FIG. 4 processes a detection signal corresponding to a position of the carriage unit 102 in synchronization with the timing based on the position signal obtained by the encoder 106 as is the case with the print head 105. A carriage belt (not illustrated) may be used to transmit a driving force from the main scanning motor 420 to the carriage unit 102. Instead of the carriage belt, the printing apparatus may include, for example, a lead screw (not illustrated) extended in the X direction and configured to be rotated by the main scanning motor 420, and an engagement portion provided to the carriage unit 102 and engaging with a groove of the lead screw. In this way, the printing apparatus may use any of other types of driving methods. The fed print medium Pis held and conveyed between a sheet feed roller 201A and a pinch roller 201B of the conveyance unit 201 and is guided to a print position (a scanning area of the print head 105) on a platen 104. In general, a face surface of the print head 105 is covered with a cap in an out-of-operation state. Therefore, a user opens the cap before printing. Thus, the user makes the print head 105 and the carriage unit 102 ready to scan. After that, once data for one scan is accumulated in a buffer (not illustrated), the printing is performed as described above by scanning the carriage unit 102 in FIGS. 1 and 2 with the main scanning motor 420 in FIG. 4. Here, a reflective optical sensor 107 in FIG. 1 includes, for example, a light-emitting portion constituted by an LED, and a light-receiving portion constituted by a photo diode. The reflective optical sensor 107 is capable of detecting a density of test patterns printed on the print medium P as an optical reflectance.

The conveyance unit 201 in FIG. 2 includes the sheet feed roller 201A and the pinch roller 201B. The spool 101 in FIG. 1 conveys the print medium P while the print medium Pis being held and is being conveyed between the sheet feed roller 201A and the pinch roller 201B. The print medium P conveyed by the spool 101 in FIG. 1 is printed by the print head 105 and then is wound around a winding spool (not illustrated). Thus, a wound medium in a roll form is formed. The print head 105 attached to the carriage unit 102 ejects inks. The print head 105 applies the inks to the print medium P while scanning in the X directions with the carriage unit 102. In this process, the print medium P is conveyed in the +Y direction intermittently by the conveyance unit 201, so that an image is formed on the surface of the print medium P. The platen 104 is arranged to face the scanning area of the print head 105 and the carriage unit 102. The platen 104 sucks the print medium P from the back surface side of the print medium P so as to prevent the print medium P from floating up. In an example of FIG. 2, the print medium P is assumed to be fed from a roll state, and then wound again into a roll state after printing. In other words, in the example of FIG. 2, a usage form of the print medium P is assumed to be a roll-to-roll form. The usage form of the print medium P is not limited to the roll-to-roll form. The usage form of the print medium P may be, for example, a cut-sheet form.

Next, a structure to fix the inks on the print medium P by drying the inks will be described. The printing apparatus includes a platen blower unit 202. The platen blower unit 202 is arranged upstream of the carriage unit 102. The platen blower unit 202 is a unit configured to blow heated air to the surface of the print medium P on the platen 104. This makes it possible to promote evaporation of moisture contained in the inks ejected on the surface of the print medium P on the platen 104 and facilitate the fixation of the inks. Specifically, the platen blower unit 202 includes a fan 202A and a heater 202B. The fan 202A includes, for example, an axial fan that functions as a blower. The heater 202B includes, for example, an electric heater that is attached to a blowing side of the fan 202A and functions as a temperature adjuster. Thus, as the heater 202B is turned on, the air blown from the fan 202A is heated. The heated air is blown from the fan 202A and passes between the print head 105 and the print medium P on the platen 104. This makes it possible to promote the evaporation of the moisture contained in the inks ejected from the print head 105 on the surface of the print medium P on the platen 104 and facilitate the fixation of the inks.

The printing apparatus includes a fixation unit 203. The fixation unit 203 is arranged downstream of the carriage unit 102. The fixation unit 203 is a unit configured to dry and fix the inks applied on the print medium P. The fixation unit 203 has a substantially box shape, and has a bottom side facing a conveyance surface of a conveyance route of the print medium P. By blowing hot air from the bottom side to the print medium P, the fixation unit 203 heats the inks and the print medium P, evaporates the water and solvents contained in the inks, and thereby turns the emulsion into a film. Specifically, the fixation unit 203 includes a fan 203A, a heater 203B, and a fixation housing 203C. The shape of the fixation housing 203C is a substantially box shape. An opening is formed at a bottom side portion of the fixation housing 203C. The fan 203A includes, for example, an axial fan that functions as a blower. The heater 203B includes, for example, an electric heater that functions as a temperature adjuster. Thus, as the heater 203B is turned on, air blown from the fan 203A is heated. The heated air is blown from the fan 203A and passes along the surface of the print medium P. This makes it possible to dry and fix the inks by faster evaporating the water and solvents contained in the inks ejected from the print head 105 onto the surface of the print medium P and turning the emulsion into the film.

The printing apparatus includes a down flow unit 204. The down flow unit 204 is arranged at a position covering the fixation unit 203 from outside. The down flow unit 204 blows the hot air discharged from the fixation unit 203 in a bottom direction. Specifically, the down flow unit 204 includes a down flow fan 204A and a down flow housing 204C. In the example of FIG. 2, the down flow housing 204C is formed in a shape covering the fixation housing 203C. The down flow housing 204C is provided with openings formed on its upstream side and its downstream side, respectively. The downstream opening of the down flow housing 204C faces in a vertical direction. Specifically, the downstream opening of the down flow housing 204C faces in the-Z direction. The down flow fan 204A includes, for example, an axial fan that functions as a blower. With this, the air taken in from the upstream of the down flow housing 204C is discharged from the downstream opening of the down flow housing 204C. This makes it possible to guide the air discharged from the fixation unit 203 in the bottom direction and blow the guided air to the bottom.

The printing apparatus includes an air curtain unit 205. The air curtain unit 205 may be provided between the platen 104 and the fixation unit 203. The air curtain unit 205 can prevent ink mists blown by the platen blower unit 202 from entering the inside of the fixation unit 203. Specifically, the air curtain unit 205 includes an air curtain fan 205A. The air curtain fan 205A includes, for example, an axial fan. The air curtain fan 205A is arranged such that the center axis of the air curtain fan 205A faces an upstream end 203CL of the bottom side portion of the fixation housing 203C. Thus, the air blown from the air curtain fan 205A passes between the bottom side portion of the fixation housing 203C and the surface of the print medium P. This can prevents the ink mists from entering the fixation unit 203.

### (Colorant-Containing Inks)

In reference to FIG. 3, ejection orifice arrays in the print head 105 will be described. The print head 105 includes ejection orifice arrays 31, 32, 33, and 34. The ejection orifice array 31 ejects a black ink as a colorant-containing ink. The ejection orifice array 32 ejects a cyan ink as a colorant-containing ink. The ejection orifice array 33 ejects a magenta ink as a colorant-containing ink. The ejection orifice array 34 ejects a yellow ink as a colorant-containing ink. Each of the black ink, the cyan ink, the magenta ink, and the yellow ink is an ink containing a colorant. In the following description, each of the colorant-containing inks also referred to as a colored ink.

### (Colorant-Free Reaction Liquid)

The print head 105 further includes an ejection orifice array 35. The ejection orifice array 35 ejects a colorant-free reaction liquid. In the present embodiment, a head structure for the ejection orifice array 35 is separated from a head structure for the colored inks. The reaction liquid (also referred to as the reaction liquid ink) contains no colorant. The reaction liquid ink contains a reactive ingredient. The reactive ingredient reacts with the colorants contained in the colored inks. Specifically, in the case where the colored inks are brought into contact with the reaction liquid ink on the print medium P, the reaction liquid ink can coagulate the colorants contained in the colored inks. In this way, the reaction liquid ink can prevent bleeding. In the present specification, the term “ink” may include not only the colored inks but also the reaction liquid ink in some cases.

The ejection orifice arrays 31 to 35 are arranged in an ejection orifice surface 105S of the print head 105 in this order from the left side to the right side in the X direction. In each of the ejection orifice arrays 31 to 35, 1280 ejection orifices 36 are arrayed in the Y direction (also referred to as the array direction) at a density of 1200 dpi. The ejection orifices 36 of the ejection orifice arrays 31 to 34 eject the colored inks. The ejection orifices 36 of the ejection orifice array 35 eject the reaction liquid ink. In the present embodiment, the volume of an ink droplet ejected at one time from each of the ejection orifices 36 is about 5 pl. Each of the ejection orifice arrays 31, 32, 33, 34, and 35 is connected to an ink tank (not illustrated) storing the corresponding ink. Thus, the ejection orifice arrays 31, 32, 33, 34, and 35 are supplied with the corresponding inks from the corresponding ink tanks (not illustrated). The print head 105 and each of the ink tanks used in the present embodiment may be structured to be separable from each other, but the structure is not limited to this. For example, the print head 105 and the ink tanks used in the present embodiment may be structured integrally. Detailed compositions of the black ink, the cyan ink, the magenta ink, the yellow ink, and the reaction liquid will be described later.

### (Controller 400)

As illustrated in FIG. 4, a control configuration of the printing apparatus includes the controller 400, an interface (I/F) 405, an operation section 406, a sensor group 411, a head driver 414, a main scanning motor driver 415, a sub-scanning motor driver 416, and a recovery processor 417. The control configuration of the printing apparatus may include a host apparatus 404. Instead, the control configuration of the printing apparatus may include an image capture section 441. In addition, the control configuration of the printing apparatus may include a display section 442. The controller 400 functions as a main control section. In an example of FIG. 4, the controller 400 includes a central processing unit (CPU) 401, a read only memory (ROM) 402, and a random access memory (RAM) 403. The controller 400 is, for example, in a microcomputer form including the CPU 401, the ROM 402, the RAM 403, and the like. In the case where the controller 400 is configured in the microcomputer form, the controller 400 may further include an I/O not illustrated. The ROM 402 stores therein a program for implementing various control modules for various kinds of control of the printing apparatus, predetermined tables, or other fixed data. In the RAM 403, an area for developing the program for implementing the various control modules, an area for developing image data, a working area, and the like are allocated as appropriate. The CPU 401 may also execute processing for impact position adjustment, which will be described later. In the processing for impact position adjustment, the CPU 401 sets an adjustment value for the impact position adjustment. This adjustment value will be used to adjust the impact positions in subsequent and later actual print processing. The host apparatus 404 is an image data supply source. The host apparatus 404 may create data on an image for printing or the like. Instead, the host apparatus 404 may preform processing or the like on image data for printing. Instead, the host apparatus 404 may be equipped with a reader section for reading images. The host apparatus 404 includes, for example, an input interface section such as a display and a keyboard, and an electric calculator capable of performing transmission and reception to and from the outside. The host apparatus 404 is capable of supplying image data, other commands, a status signal, and the like to the controller 400 via the interface (I/F) 405. Thus, the controller 400 transmits and receives the image data, the other commands, the status signal, and the like via the interface (I/F) 405. The host apparatus 404 may be implemented by another printing apparatus. Instead, the host apparatus 404 may be implemented by a terminal such as a smartphone.

### (Operation Section 406)

The operation section 406 includes a power switch 407, a print start switch 408, a recovery switch 409, and an impact position adjustment start switch 410. The operation section 406 has a function to receive an instruction input by an operator (also referred to as the user). In the operation section 406, the power switch 407, the print start switch 408, the recovery switch 409, and the impact position adjustment start switch 410 function as a switch group. The power switch 407 is a switch for switching whether or not to supply power from a power source to the printing apparatus. As the power source, a commercially available power source may be used, but the power source is not particularly limited to this. For example, in the case where the printing apparatus includes a secondary battery therein, the secondary battery may be used as the power source. The print start switch 408 is a switch for instructing the printing apparatus to start printing on the print medium P. The recovery switch 409 is a switch for instructing start of a sucking and recovery operation on the print head 105. The impact position adjustment start switch 410 is a switch for the impact position adjustment for the inks. In the present embodiment, it is assumed that the print start, the recovery operation, and the impact position adjustment are executed in response to the operations of the switches provided to a printing apparatus main body. However, the print start, the recovery operation, and the impact position adjustment may be executed based on instructions from the host apparatus 404. The operation section 406 may further include an input section 431. The input section 431 has a function to receive an input by the user. For example, in the case where information contained in a user's input received in the input section 431 indicates print information on printed image states of multiple test patterns on a print medium P, the CPU 401 may cause the RAM 403 to store the received user's input as the print information. Although not illustrated, a storage device to store the print information may be provided outside the controller 400. This storage device may include, for example, a hard disc drive (HDD). Instead, the storage device may include, for example, a semiconductor memory such as a solid state drive (SSD).

### (Sensor Group 411)

The sensor group 411 includes a photocoupler 412 and a temperature sensor 413. The sensor group 411 has a function to detect conditions of the printing apparatus. The sensor group 411 may include, for example, the reflective optical sensor 107 in FIG. 1. The photocoupler 412 detects a home position of the carriage unit 102. The temperature sensor 413 detects an environment temperature. The temperature sensor 413 is installed on a suitable portion. For example, the temperature sensor 413 may be installed on an air blowing port of the platen blower unit 202 in FIG. 2. In this installation structure, the temperature of the air blown from the platen blower unit 202 in FIG. 2 can be detected.

### (Head Driver 414)

The print head 105 in FIG. 2 includes ejection heaters 419 in FIG. 4 and sub-heaters 418 in FIG. 4. Each of the ejection heaters 419 has a function to generate a bubble in the ink in a corresponding pressure chamber (not illustrated) to eject the ink from the corresponding one of the ejection orifices 36 in FIG. 3. Each of the sub-heaters 418 has a function to adjust the temperature for stabilizing the ejection characteristics of the ink. The sub-heaters 418 are formed concurrently with the ejection heaters 419 on a substrate of the print head 105. Instead, the sub-heaters 418 may be attached to the print head 105. The head driver 414 in FIG. 4 has a function to drive the ejection heaters 419 according to print data. Specifically, the head driver 414 includes a shift register, a latch circuit, and a logic circuit element. The shift register has a function to align print data corresponding to the positions of the ejection heaters 419. The latch circuit has a function to perform latch at appropriate timing. The logic circuit element has a function to operate the ejection heaters 419 in synchronization with a drive timing signal.

### (Main Scanning Motor Driver 415; Sub-Scanning Motor Driver 416; and Recovery Processor 417)

The main scanning motor driver 415 has a function to drive the main scanning motor 420. The main scanning motor 420 has a function to generate a driving force to move the carriage unit 102 including the print head 105 in the X directions. The sub-scanning motor 421 has a function to generate a driving force to convey the print medium P in the Y direction (also referred to as the sub-scanning direction) via the conveyance unit 201. The sub-scanning motor driver 416 has a function to drive the sub-scanning motor 421. The recovery processor 417 has a function to perform recovery processing for maintaining the ejections of the print head 105 in good conditions.

### (Image Capture Section 441)

The image capture section 441 is arranged downstream of the fixation unit 203. The image capture section 441 has a function to capture an image of multiple test patterns printed on a print medium P after passing through the fixation unit 203. The image capture section 441 includes, for example, a charge coupled device (CCD) image sensor. Instead, the image capture section 441 may include a complementary metal oxide semiconductor (CMOS) image sensor. The CPU 401 may cause the RAM 403 or the storage device to store, as the print information, a prediction result of prediction made based on the image of the multiple test patterns captured by the image capture section 441. The image of the test patterns will be described in detail later.

### (Display Section 442)

The display section 442 has a function to display information on the image of the multiple test patterns and various kinds of information on internal conditions and the like of the printing apparatus. The display section 442 includes, for example, a liquid crystal display. Instead, the display section 442 may include, for example, multiple LEDs and inform the user of the various kinds of information by using blinking patterns of these LEDs. The function of the operation section 406 may be structured by a touch panel, and a touch panel display may be structured by stacking the touch panel onto the liquid crystal display. With this structure, the function of the operation section 406 and the function of the display section 442 may be implemented in one unit.

### (Multi-Pass Printing Control)

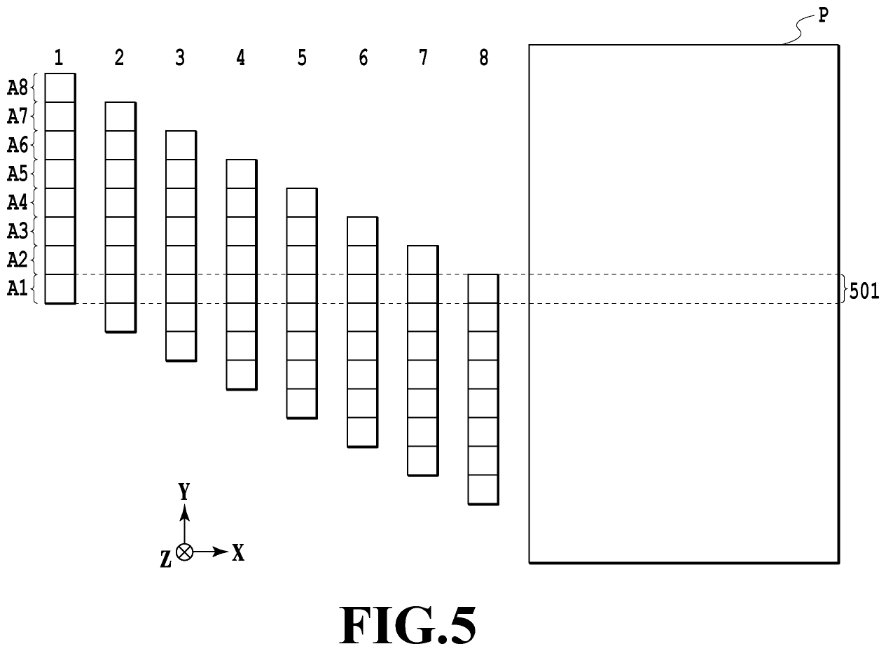

Next, multi-pass printing control in the printing apparatus described in reference to FIGS. 1 to 4 will be described in reference to FIG. 5. FIG. 5 is a schematic diagram illustrating the multi-pass printing control. The multi-pass printing control is control for printing on a unit area 501 of a print medium P with multiple scans by using the colored inks and the reaction liquid. An image is printed on the print medium P by the multi-pass printing control. FIG. 5 illustrates an example in which the printing on the unit area 501 is completed by eight scans. In FIG. 5, eight ejection orifice groups A1 to A8 are formed by dividing each of the ejection orifice arrays 31 to 35 in FIG. 3 in the Y direction. In each of the eight scans performed on the unit area 501, the colored inks and the reaction liquid are ejected from the corresponding ones of the eight ejection orifice groups A1 to A8. During the ejections, the print medium P is actually conveyed to the downstream side in the Y direction between the scans of the print head 105. For simplification, FIG. 5 illustrates the diagram as if the print head 105 were moved to the upstream side in the Y direction between the scans of the print head 105. In the 1st scan, the print head 105 is scanned with a positional relationship in which the ejection orifice groups A1 in the respective ejection orifice arrays 31 to 35 face the unit area 501 of the print medium P. As a result, the colored inks and the reaction liquid are ejected from the ejection orifice groups A1 onto the unit area 501 according to print data allocated to the 1st scan. After the end of the 1st scan, the print medium P is conveyed in the Y direction by a distance corresponding to one ejection orifice group. Then, the 2nd scan is performed. As a result, the colored inks and the reaction liquid are ejected from the ejection orifice groups A2 onto the unit area 501 according to print data allocated to the 2nd scan. In the subsequent 3rd to 8th scans, the conveyance of the print medium P and the ejection from the print head 105 are alternately performed. In this way, the ejections from the ejection orifice groups A1 to A8 are executed in the 1st to 8th scans on the unit area 501. Thus, the multi-pass printing on the unit area 501 is completed. Needless to say, printing on other unit areas is concurrently performed in the same manner with different ejection orifice groups associated with the respective other unit areas.

### (Mask Patterns)

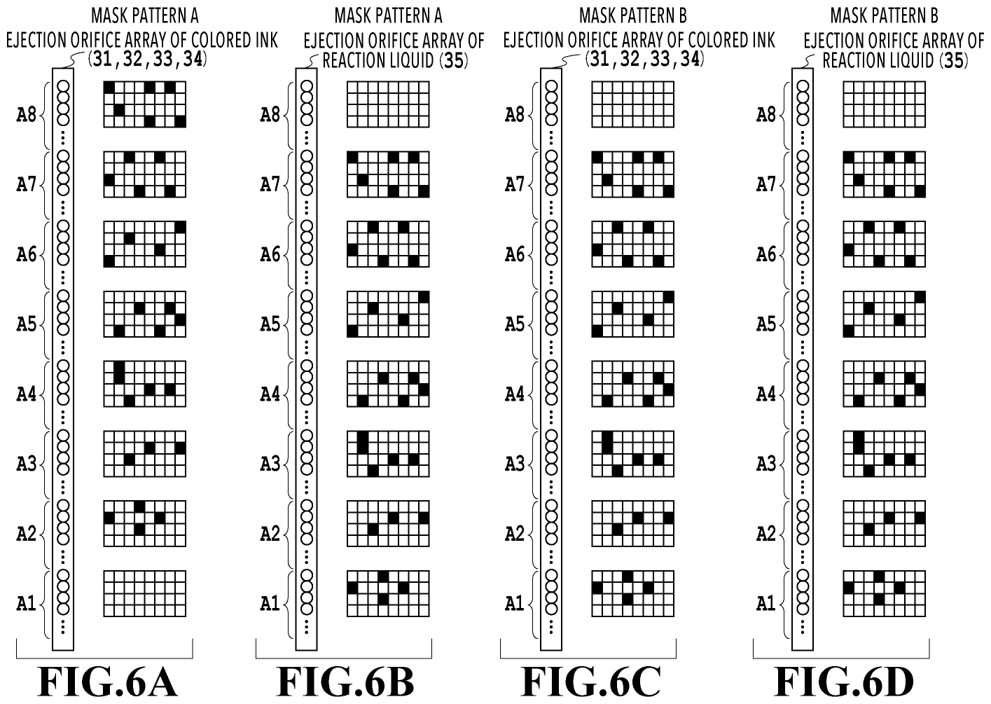

FIGS. 6A to 6D are schematic diagrams for explaining mask patterns. In each of the mask patterns illustrated in FIGS. 6A to 6D, black-colored pixels (hereinafter also referred to as elements) indicate pixels on which ink ejection is permitted in quantized data in the case where the ink ejection is prescribed in the quantized data. In each of the mask patterns illustrated in FIGS. 6A to 6D, white-colored pixels (elements) indicate pixels on which ink ejection is not permitted in the quantized data in the case where the ink ejection is prescribed in the quantized data. FIGS. 6A to 6D present mask patterns of 4 pixels× 8 pixels. Processing of allocating all the quantized data to all the unit areas 501 in FIG. 5 is performed by repeatedly applying each of the mask patterns illustrated in FIGS. 6A to 6D in X direction and the Y direction. FIG. 6A illustrates a mask pattern group to be applied to the quantized data for the colored ink ejection orifice arrays, namely, the black ink ejection orifice array 31, the cyan ink ejection orifice array 32, the magenta ink ejection orifice array 33, and the yellow ink ejection orifice array 34. As illustrated in FIG. 6A, regarding the colored ink ejection orifice arrays 31 to 34, print-permitted pixels are arranged only in the mask patterns for the ejection orifice groups A2 to A8 assigned to the 2nd to 8th scans among the ejection orifice groups A1 to A8 assigned to the 1st to 8th scans. Meanwhile, no print-permitted pixel is arranged in the mask pattern for the ejection orifice group A1 assigned to the 1st scan. Thus, in the present embodiment, the colored inks are ejected only in the 2nd to 8th scans among the eight scans. On the other hand, as illustrated in FIG. 6B, regarding the reaction liquid ejection orifice array 35, print-permitted pixels are arranged in the mask patterns for the ejection orifice groups A1 to A7 assigned to the 1st to 7th scans among the ejection orifice groups A1 to A8 assigned to the 1st to 8th scans. Then, no print-permitted pixel is arranged in the mask pattern for the ejection orifice group A8 assigned to the 8th scan. Accordingly, in the present embodiment, the reaction liquid is ejected only in the 1st to 7th scans among the eight scans. As described above, the reaction liquid is ejected onto a print medium prior to the ejection of the colored inks. For this reason, immediately after the colored inks are ejected onto the print medium, the colorants in the colored inks start coagulation with the reaction liquid. This makes it possible to suitably reduce bleeding of the colored inks. Instead, depending on a print medium P, the mask patterns may be changed to mask patterns as illustrated in FIGS. 6C and 6D, so that the colored inks and the reaction liquid can be ejected concurrently in the same print scan. In the present embodiment, FIGS. 6A and 6B present a mask pattern A, while FIGS. 6C and 6D present a mask pattern B. The print medium printed with the colored inks and the reaction liquid is conveyed and passes along the fixation unit 203 and thereby the inks are heated and dried. In this way, even on a non-absorbent or hardly-absorbent print medium, the inks are fixed and the printing is completed.

### (Ink Compositions)

Hereinafter, a composition of each of the inks will be described in detail. All of the colored inks and the reaction liquid used in the present embodiment contain water-soluble organic solvents. The water-soluble organic solvents preferably have a boiling point of 150° C. or more and 300° C. or less from the viewpoints of the wettability and moisture retention of the face surface of the print head 105. Particularly preferred water-soluble organic solvents include ketone compounds such as acetone and cyclohexanone, ethylene glycol derivatives such as tetraethylene glycol dimethyl ether, and the like. In addition, other particularly preferred water-soluble organic solvents include heterocyclic compounds having a lactam structure represented by N-methyl-pyrrolidone and 2-pyrrolidone and the like. From the viewpoint of ejection characteristics, a content of the water-soluble organic solvent is preferably 3 wt % or more and 30 wt % or less. Specific examples of the water-soluble organic solvents include methyl alcohol, ethyl alcohol, n-propyl alcohol, isopropyl alcohol, n-butyl alcohol, and so on. Other specific examples of the water-soluble organic solvents include sec-butyl alcohol, tert-butyl alcohol, and so on. These are alkyl alcohols having 1 to 4 carbon atoms. Moreover, other examples of the water-soluble organic solvents include: amides such as dimethylformamide and dimethylacetamide; ketones or ketoalcohols such as acetone and diacetone alcohol; ethers such as tetrahydrofuran and dioxane; polyalkylene glycols such as polyethylene glycol and polypropylene glycol; ethylene glycol; or alkylene glycols with an alkylene group having 2 to 6 carbon atoms such as propylene glycol, butylene glycol, triethylene glycol, 1,2,6-hexanetriol, thiodiglycol, hexylene glycol, and diethylene glycol; lower alkyl ether acetates such as polyethylene glycol monomethyl ether acetate; glycerin; lower alkyl ethers of multivalent alcohols such as ethylene glycol monomethyl (or ethyl) ether, diethylene glycol methyl (or ethyl) ether, and triethylene glycol monomethyl (or ethyl) ether; multivalent alcohols such as trimethylolpropane and trimethylolethane; N-methyl-2-pyrrolidone, 2-pyrrolidone, 1,3-dimethyl-2-imidazolidinone, and the like. The water-soluble organic solvents as listed above may be each used alone or be used as a mixture of two or more. As water, deionized water is desirably used. The content of the water-soluble organic solvent in the reaction liquid (RCT) is not particularly limited. Meanwhile, to each of the colorant inks (C, M, Y, K), a surfactant, a defoamer, a preservative, an antifungal agent, and the like may be added as appropriate in addition to the above-mentioned ingredient in order to impart desired physical properties as needed.

All the colored inks and the reaction liquid used in the present embodiment contain a surfactant. The surfactant is used as a penetrant to improve the ink's penetration power into print media dedicated for inkjet printing. As the amount of the surfactant added increases, the surfactant exerts a stronger ability to lower the surface tension of the ink, thereby improving the ink's wetting power and penetration power to a print medium. In the present embodiment, each of the inks was adjusted with addition of a small amount of acetylene glycol EO adduct or the like as the surfactant so that the surface tension of each of the inks was 30 dyn/cm or less and the difference in surface tension among the inks was 2 dyn/cm or less. More specifically, each of the inks was adjusted to have a surface tension of about 28 to 30 dyn/cm. The surface tension was measured by using an fully-automatic surface tensiometer CBVP-Z (manufactured by Kyowa Interface Science Co., Ltd.). A measurement device is not limited to the above example, as long as the surface tensions of the inks can be measured.

In the present embodiment, the pH of each of the inks was stable on an alkali side with the value ranging from 8.5 to 9.5. The pH of each of the inks is preferably 7.0 or more and 10.0 or less in order to prevent elution or deterioration of members to come into contact with the inks in the printing apparatus and the print head and to prevent a decrease in the solubility of dispersion resins in the inks and the like. The pH was measured by using a pH meter of a model F-52 manufactured by Horiba Ltd. A measurement device is not limited to the above example, as long as the pH of the inks can be measured.

Hereinafter, among the black ink, the cyan ink, the magenta ink, and the yellow ink used in the present embodiment, the cyan ink and the magenta ink will be described in detail for simplification.

### (Magenta Ink)

### (Preparation of Dispersion)

First, an AB-type block polymer with an acid value of 300 and a number average molecular weight of 2500 was prepared by a usual method using benzyl acrylate and methacrylic acid as raw materials, then neutralized with an aqueous potassium hydroxide solution, and diluted with ion-exchanged water to prepare a homogeneous 50% by mass polymer aqueous solution. Then, 100 g of the above polymer solution, 100 g of C.I. Pigment Red 122, and 300 g of ion-exchanged water were mixed and mechanically stirred for 0.5 hours. Next, using a microfluidizer, the mixture was processed by being passed through an interaction chamber five times under a liquid pressure of about 70 MPa. Further, the dispersion obtained above was centrifuged (12,000 rpm, 20 minutes) to remove non-dispersed substances including coarse particles, thereby obtaining a magenta dispersion. The obtained magenta dispersion had a pigment concentration of 10% by mass and a dispersant concentration of 5% by mass.

Next, ink preparation of the magenta ink will be described. In the ink preparation, the above magenta dispersion was used and adjusted to a predetermined concentration with addition of the following ingredients thereto. These ingredients were thoroughly mixed and stirred, then filtered under pressure through a microfilter with a pore size of 2.5 μm (manufactured by FUJIFILM Corporation) to prepare a colorant ink with a pigment concentration of 4% by mass and a dispersant concentration of 2% by mass.

| | | |
|---|---|---|
| Magenta dispersion described above | 40 | parts |
| 2-Pyrrolidone | 5 | parts |
| 2-Methyl-1,3-propanediol | 15 | parts |
| Acetylene glycol EO adduct | 0.5 | parts |

Ion-exchanged water (manufactured by Kawaken Fine Chemical Co., Ltd.) Balance (Cyan Ink)

### (Preparation of Dispersion)

First, an AB-type block polymer with an acid value of 250 and a number average molecular weight of 3000 was prepared by a usual method using benzyl acrylate and methacrylic acid as raw materials, then neutralized with an aqueous potassium hydroxide solution, and diluted with ion-exchanged water to prepare a homogeneous 50% by mass polymer aqueous solution. Then, 180 g of the above polymer solution, 100 g of C.I. Pigment Blue 15:3, and 220 g of ion-exchanged water were mixed and mechanically stirred for 0.5 hours.

Next, using the microfluidizer, the mixture was processed by being passed through the interaction chamber five times under a liquid pressure of about 70 MPa.

Further, the dispersion obtained above was centrifuged (12,000 rpm, 20 minutes) to remove non-dispersed substances including coarse particles, thereby obtaining a cyan dispersion. The obtained cyan dispersion had a pigment concentration of 10% by mass and a dispersant concentration of 10% by mass.

### (Cyan Ink)

### (Ink Preparation)

In the ink preparation, the above cyan dispersion was used and adjusted to a predetermined concentration with addition of the following ingredients thereto. These ingredients were thoroughly mixed and stirred, then filtered under pressure through a microfilter with a pore size of 2.5 um (manufactured by FUJIFILM Corporation) to prepare a colorant ink with a pigment concentration of 4% by mass and a dispersant concentration of 2% by mass.

| | | |
|---|---|---|
| Cyan dispersion described above | 20 | parts |
| 2-Pyrrolidone | 5 | parts |
| 2-Methyl-1,3-propanediol | 15 | parts |
| Acetylene glycol EO adduct | 0.5 | parts |

Ion-exchanged water (manufactured by Kawaken Fine Chemical Co., Ltd.) Balance

The reaction liquid used in the present embodiment contains a reactive ingredient that reacts with the pigments contained in the inks to form a coagulation or a gel of the pigments. Specifically, this reactive ingredient is an ingredient that, in the case where the ingredient is mixed, on a print medium or the like, with an ink containing a pigment stably dispersed or dissolved in an aqueous medium, can destroy the dispersion stability of the ink through an action of ionic groups. To be more specific, in the present embodiment, glutaric acid is used as will be described below.

However, the glutaric acid does not have to be necessarily used, and any of various water-soluble organic acids may be used as a reactive ingredient of the reaction liquid. Specific examples of the organic acids include oxalic acid, polyacrylic acid, formic acid, acetic acid, propionic acid, glycolic acid, malonic acid, malic acid, maleic acid, ascorbic acid, levulinic acid, and succinic acid. In addition, the specific examples of the organic acids further include glutaric acid, glutamic acid, fumaric acid, citric acid, tartaric acid, lactic acid, pyrrolidone carboxylic acid, pyrone carboxylic acid, and pyrrole carboxylic acid. Further, the specific examples of the organic acids further include furan carboxylic acid, pyridine carboxylic acid, coumaric acid, thiophene carboxylic acid, nicotinic acid, oxysuccinic acid, and dioxysuccinic acid. A content of the organic acid based on the total mass of the composition contained in the reaction liquid is preferably 3.0% by mass or more and 90.0% by mass or less and more preferably 5.0% by mass or more and 70.0% by mass or less.

### (Reaction Liquid)

### (Ink Preparation)

In the present embodiment, the reaction liquid was prepared by mixing the following ingredients while using glutaric acid (manufactured by Wako Pure Chemical Industries, Ltd.) as the organic acid as described above.

| | | |
|---|---|---|
| Glutaric acid | 3 | parts |
| 2-Pyrrolidone | 5 | parts |
| 2-Methyl-1,3-propanediol | 15 | parts |
| Acetylene glycol EO adduct | 0.5 | parts |

Ion-exchanged water (manufactured by Kawaken Fine Chemical Co., Ltd.) Balance

In a printing method using the colored inks and the reaction liquid, the same area is printed with required volumes of the colored inks and a required volume of the reaction liquid. Thus the reaction liquid comes into contact with the colored inks at a certain frequency. This may make it possible to obtain an effect of preventing bleeding, which may otherwise occur noticeably particularly on non-absorbent media. The print medium printed with the colored inks and the reaction liquid is conveyed and passes along the fixation unit 203 and thereby the inks are heated and dried. In this way, even on a non-absorbent or hardly-absorbent print medium, the inks are fixed and the printing is completed.

### (Print Media)

The printing apparatus in the present embodiment is capable of printing multiple types of print media. The printable print media P in the present embodiment can be roughly classified into three types. The first type is non-absorbent print media into which the moisture contained in the colored ink cannot penetrate. The second type is hardly-absorbent print media which have low absorbency of the moisture contained in the colored inks. The third type is print media suitable for inkjet printing which has high moisture absorbency.

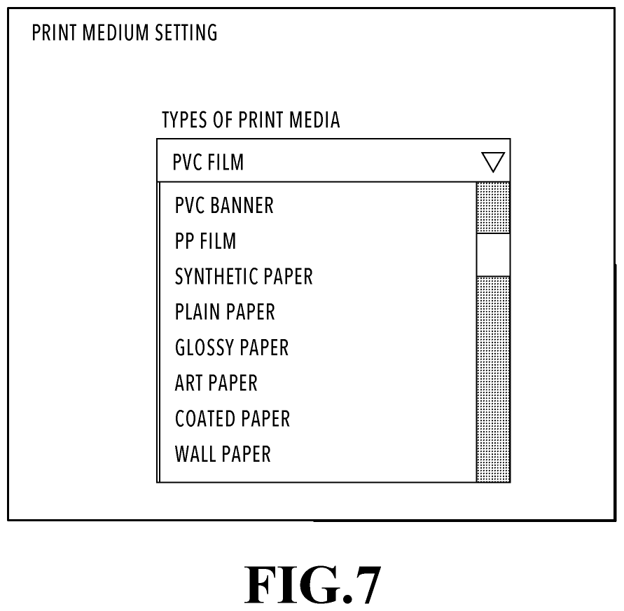

FIG. 7 is a schematic view illustrating a user interface (UI) for print medium selection. FIG. 7 is the view schematically illustrating a screen (UI) provided on the display of the host apparatus 404 in order for the user to input information on a type of print medium. In an example of FIG. 7, eight types of print media are displayed: “PVC film”, “PVC banner”, “PP film”, “Synthetic paper”, “Plain paper”, “Glossy paper”, “Art paper”, “Coated paper”, and “Wall paper”. Among them, “PVC film”, “PVC banner”, “PP film”, and “Synthetic paper” are print media which the moisture contained in the colored inks is unlikely to penetrate. An example of “Synthetic paper” is “Yupo (registered trademark)”. There are a print medium having the outermost surface of a base material coated with a plastic layer, a print medium without an ink-receiving layer formed on a base material, and sheets, films, banners, and the like made of glass, synthetic paper, plastic, and the like. Examples of the above coating plastic include polyvinyl chloride, polyethylene terephthalate, polycarbonate, polystyrene, polyurethane, polyethylene, polypropylene, and so on. These print media with low absorbency are excellent in terms of water resistance, light resistance, and scratch resistance and therefore are generally used for printing of print products intended for outdoor exhibition. Meanwhile, “Glossy paper”, “Art paper”, and “Coated paper” are highly-absorbent print media suitable for inkjet printing that allow the moisture contained in colored inks to penetrate. These print media are inferior to the print media with low absorbency in terms of water resistance, light resistance, and scratch resistance, but are excellent in color development owing to the ability to absorb the applied colored inks in the ink-receiving layer, and therefore can achieve printing with high image quality. For this reason, these print media are generally used for printing of print products intended for indoor exhibition. These print media have such high absorbency as to allow the colored inks to penetrate the print media before the colored inks come into contact with each other, and thereby do not need a reaction liquid. Meanwhile, “Plain paper” and “Wall paper” are classified into the hardly-absorbent print media which absorb the moisture slowly because their surface layers are made of pulp materials or have coating layers. On a hardly-absorbent print medium, the colored inks come into contact with each other before the colored inks are absorbed in the print medium and bleeding of the colored inks occurs. For this reason, on a hardly-absorbent print medium, bleeding of the colored inks is also prevented by the reaction liquid. In order to classify print media into the hardly-absorbent print media and the non-absorbent print media, a volume of liquid transferred per unit time Vt is used as an indicator for quantifying the “absorbency” of a print medium. One method for measuring the volume of liquid transferred Vt is the “Bristow method”, which measures the volume of water absorbed for a short period of time immediately after contact with the water. In the Bristow method, a certain volume of liquid V is put in a container with a small opening, an area wL of a portion of a paper surface to which the liquid is transferred is measured while the opening is brought into contact with the paper surface, and then the volume of liquid transferred per unit time Vt can be calculated in accordance with Formula Vt=V/wL.

### (Wettability)

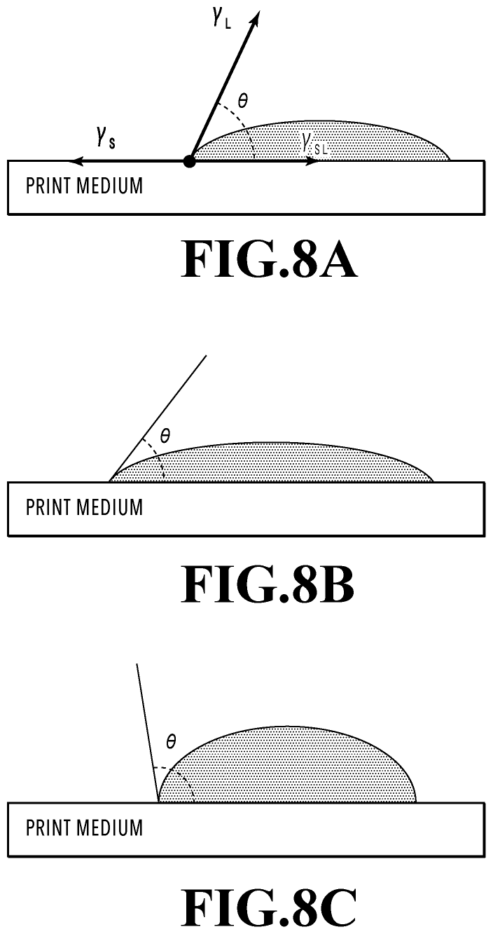

However, the measurement of the volume of ink transferred to a print medium needs to use a device dedicated for Bristow's measurement, and it is difficult to incorporate such a device into a general printing apparatus. In addition, irrespective of whether a print medium is a non-absorbent print medium which the moisture contained in the colored inks is unlikely to penetrate or a hardly-absorbent print medium which has low absorbency of the moisture contained in the colored inks, the surface tension of the colored inks applied to the print medium varies depending on the surface energy of the surface layer of the print medium. For this reason, print media P are classified into print media P having an easily wettable property and print media P having a hardly wettable property. An indicatory for quantifying the “wettability” of a print medium is a “contact angle” (θ: Contact AngLe). FIGS. 8A to 8C are diagrams for explaining the quantification of the “wettability” of print media. FIG. 8A illustrates an example of parameters for determining a contact angle θ, which is an angle between the tangent of a droplet and a solid surface. As illustrated in FIG. 8A, the contact angle θ is referred to as the “contact angle” and can be calculated in accordance with Young's equation γs=γL·cosθ+γsL. FIG. 8B is a diagram illustrating a print medium P having an easily wettable property. The print medium P having an easily wettable property has a small contact angle θ, and allows wetting with an applied liquid such as a colored ink to spread. FIG. 8C is a diagram illustrating a print medium P having a hardly wettable property. The print medium P having a hardly wettable property has a large contact angle θ and does not allow wetting with an applied liquid such as a colored ink to spread. However, the measurement of the contact angle θ as the angle between a print medium P and a colored ink needs to use a dedicated contact angle meter, and it is difficult to incorporate such dedicated contact angle meter into a general printing apparatus. In the case of using a pre-registered print medium, the “absorbency” or “wettability” can be collected in advance and a printer unit suitable for the “absorbency” or “wettability” can be prepared and provided in advance.

### (Classification of Print Media)

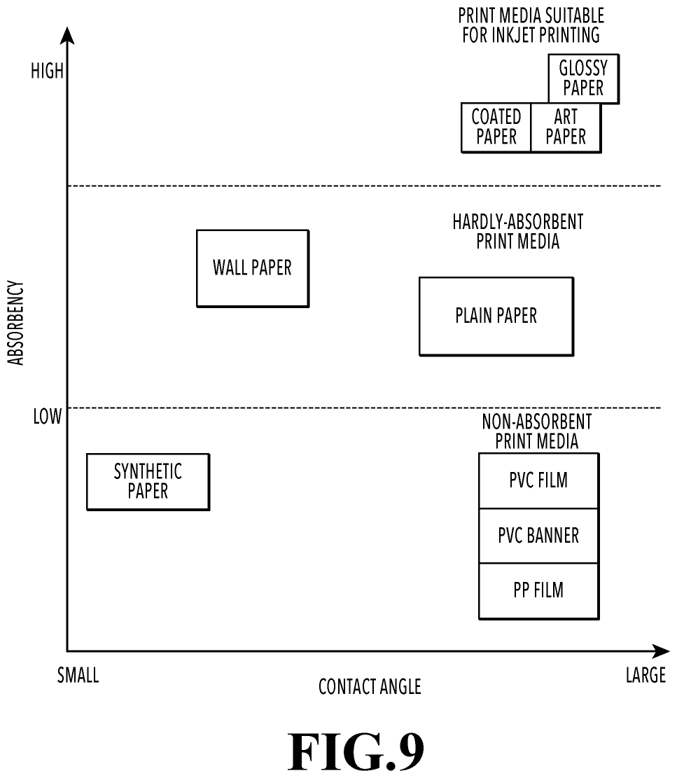

FIG. 9 is a diagram for explaining print medium classification according to the “absorbency” and “wettability” of print media. As described above, the “absorbency” is classified depending on a base material or coating, and “Glossy paper”, “Art paper”, and “Coated paper” are classified into print media suitable for inkjet printing. Then, “Plain paper” and “Wall paper” are classified into hardly-absorbent print media. In addition, “PVC film”, “PVC banner”, “PP film”, and “Synthetic paper” are classified into non-absorbent print media. Meanwhile, regarding “wettability, the “wettability” of a print medium may vary greatly depending on processing conditions, a material formulation, or the like. For example, among the non-absorbent print media, “PVC film”, “PVC banner”, and “PP film” are classified into print media P having a hardly wettable property because they have relatively large contact angles. Meanwhile, “Synthetic paper” is classified into print media P having an easily wettable property because it has a relatively small contact angle. In this way, the wettability of print media varies widely. For this reason, it is difficult to predict the wettability of a print medium which is not registered in advance.

### (Drying Conditions)

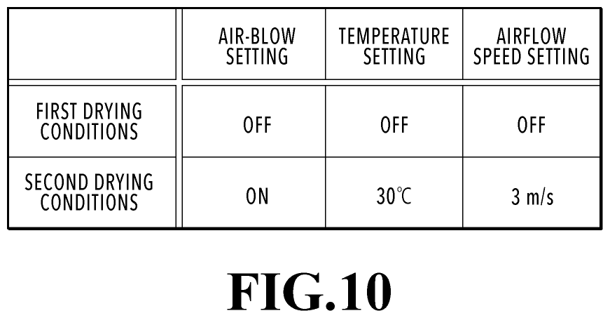

FIG. 10 is a diagram for explaining drying conditions. As specified in FIG. 10, the drying conditions includes first drying conditions and second drying conditions. The first drying conditions include an air-blow setting of causing control to keep air supply from being stopped. The second drying conditions include an air-blow setting of causing control to perform air supply. In both the first drying conditions and the second drying conditions, the platen blower unit 202 is in charge of the air supply. However, an air supplier may be any device other than the platen blower unit 202. The device is not particularly limited as long as it can evaporate the moisture in the inks on a print medium P.

The first drying conditions include at least one of the air-blow setting, a temperature setting, and an airflow speed setting. In the example of FIG. 10, the first drying conditions are set with the air-blow setting of “OFF”, the temperature setting of “OFF”, and the airflow speed setting of “OFF”. Meanwhile, in the example of FIG. 10, the second drying conditions include at least one of the air-blow setting, the temperature setting, and the airflow speed setting as in the first drying conditions. In the example of FIG. 10, the second drying conditions are set with the air-blow setting of “ON”, the temperature setting of “30° C.”, and the airflow speed setting of “3 m/s”. The drying conditions may further include an airflow volume setting. For example, as the rotation speed of the fan 202A increases, the volume of airflow blown from the fan 202A increases. Thus, the airflow volume may be set by using the rotation speed of the fan 202A. Here, the amount of ink mists may increase as the airflow volume increases. To address this, in the case where the airflow volume is increased by increasing the rotation speed of the fan 202A, the rotation speed of the air curtain fan 205A may be also increased. Alternatively, more powerful drying conditions (third drying conditions) than the second drying conditions may be added. For example, the third drying conditions may be set with the air-blow setting of “ON”, the temperature setting of “35° C.”, and the airflow speed setting of “6 m/s”.

### (Test Patterns)

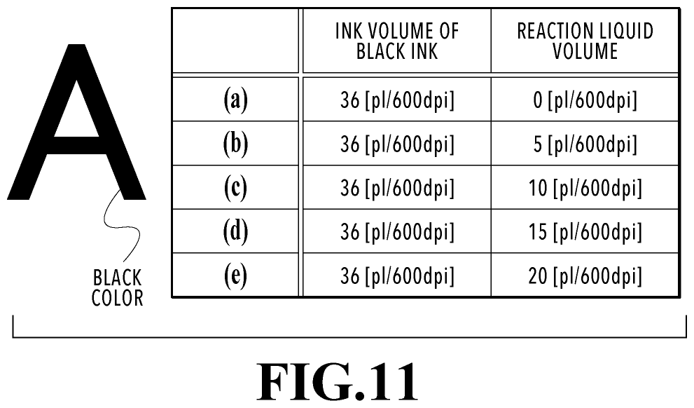

FIG. 11 is a diagram for explaining test patterns. In FIG. 11, [pl/dpi] is a unit for a volume of droplets per unit area. In the example of FIG. 11, [pl/600 dpi] is used. This means that the unit area is a line of 1 inch (about 2.54 cm) where 600 droplets can be placed. That is, the volume of droplets is at a density of 600 droplets per inch. FIG. 11 illustrates an alphabet letter “A” as an example of the test patterns. The latter “A” is constituted by a colored ink and the reaction liquid. As the colorant contained in the colored ink, the black ink is used. The black ink volume per unit area is 36 [pl/600 dpi]. As the reaction liquid volume, five levels (a), (b), (c), (d), and (e) are tried as illustrated in FIG. 11. The reaction liquid volume per unit area (a) is 0 [pl/600 dpi]. The reaction liquid volume per unit area (b) is 5 [pl/600 dpi]. The reaction liquid volume per unit area (c) is 10 [pl/600 dpi]. The reaction liquid volume per unit area (d) is 15 [pl/600 dpi]. The reaction liquid volume per unit area (e) is 20 [pl/600 dpi]. The test patterns illustrated in FIG. 11 are printed by printing five letters “A” on a print medium P while applying the reaction liquid volumes (a) to (e) to the respective five letters “A” by multi-pass printing using the mask pattern A in FIG. 6B. In the case where images for multiple test patters as described above are formed, it is possible to determine which of the reaction liquid volumes results in spreading of the colored ink based on the images for the test patterns. Specifically, it is checked whether or not the colored ink spreads beyond a border between an area printed with the colored ink and an area not printed with the colored ink. If the colored ink spreads beyond this border, the image printed with the colored ink is bleeding. Thus, it is possible to visually check whether the bleeding occurs.

### (Without Air Blowing (First Drying Conditions); Hardly Wettable (Low Wettability))

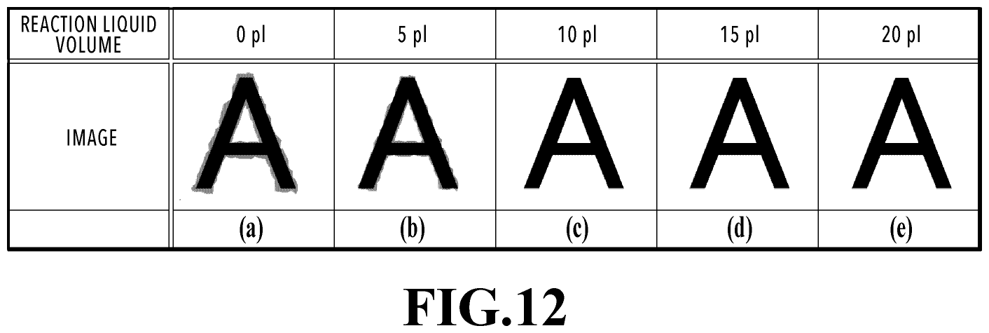

FIG. 12 is a diagram illustrating print results of the test patters on a print medium having a hardly wettable property under the first drying conditions. Specifically, FIG. 12 presents the results of printing all the test patterns in FIG. 11 on the print medium having a hardly wettable property illustrated in FIG. 8C under the first drying conditions in FIG. 10. The images (a) to (e) in FIG. 12 respectively represent images printed under the conditions specified in (a) to (e) of FIG. 11. The images (a) and (b) in FIG. 12 representing the images under the conditions (a) and (b) in FIG. 11 indicate that the reaction liquid volumes are insufficient to coagulate the colored ink. For this reason, the letters “A” are bleeding. On the other than, the letters “A” are not bleeding in the images (c), (d), and (e) in FIG. 12 representing the images under the conditions (c), (d), and (e) in FIG. 11 in which the reaction liquid volumes are 10 [pl/600 dpi] or more.

### (Without Air Blowing (First Drying Conditions); Easily Wettable (High Wettability))

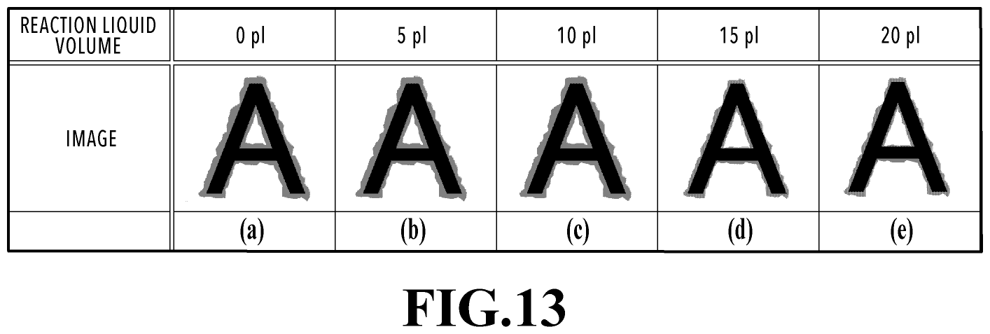

FIG. 13 is a diagram illustrating print result of the test patters on a print medium having an easily wettable property under the first drying conditions. Specifically, FIG. 13 presents the results of printing all the test patterns in FIG. 11 on the print medium having an easily wettable property illustrated in FIG. 8B under the first drying conditions in FIG. 10. The images (a) to (e) in FIG. 13 respectively represent images printed under the conditions specified in (a) to (e) of FIG. 11. In all the images (a) to (e) in FIG. 13 representing the images under the conditions (a) to (e) in FIG. 11, it is seen that the wetting with the colored ink spreads from the letters “A”. Thus, phenomena of spreading of the ink beyond the predetermined position occur in all the images (a) to (e) in FIG. 13.

### (With Air Blowing (Second Drying Conditions); Easily Wettable (High Wettability))

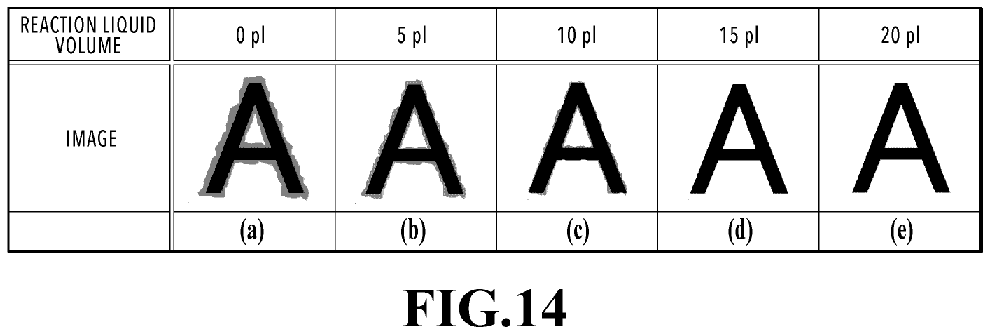

FIG. 14 is a diagram illustrating print results of the test patters on a print medium having an easily wettable property with air blowing. Specifically, FIG. 14 presents the results of printing all the test patterns in FIG. 11 on the print medium having an easily wettable property illustrated in FIG. 8B under the second drying conditions in FIG. 10. The images (a) to (e) in FIG. 14 respectively represent images printed under the conditions specified in (a) to (e) of FIG. 11. In each of the images (a) to (c) in FIG. 14 representing the images under the conditions (a) to (c) in FIG. 11, it is seen that the wetting with the colored ink spreads beyond the letter “A”. Thus, the phenomena of spreading of the ink beyond the predetermined position occur in the images (a) to (c) in FIG. 14. On the other hand, a phenomenon of spreading from the letter “A” occurs in none of the images (d) and (e) in FIG. 14 representing the images under the conditions (d) and (e) in FIG. 11 in which the reaction liquid volumes are 15 [pl/600 dpi] or more.

### (Operation Example)

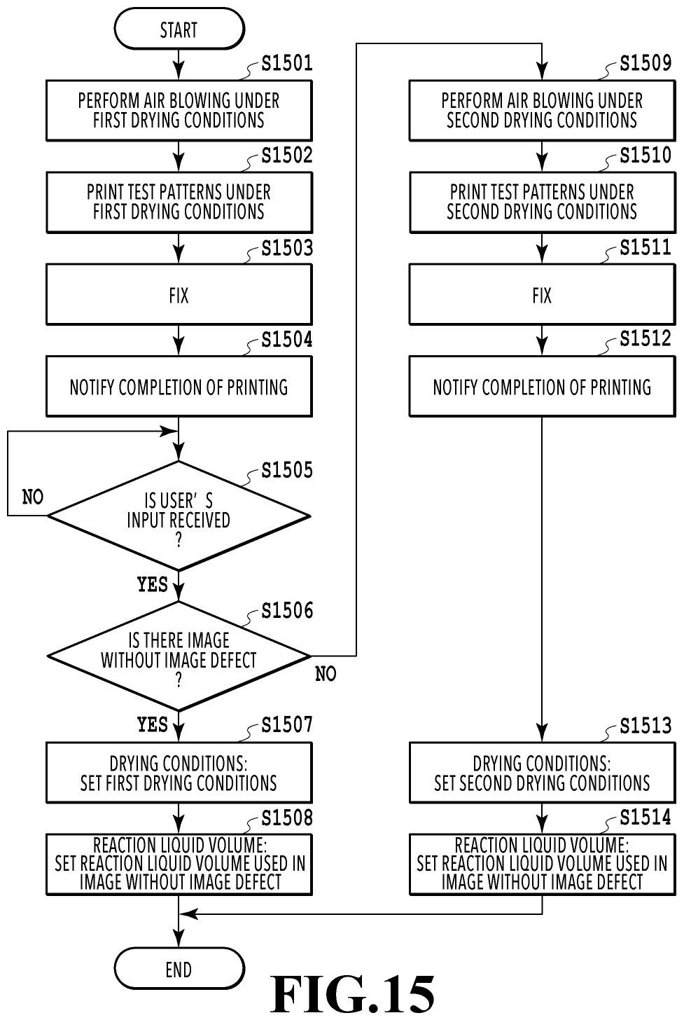

FIG. 15 is a flowchart presenting processing for determining the drying conditions and the reaction liquid volume according to the first embodiment of the present disclosure. The processing presented in FIG. 15 is implemented by the CPU 401 reading out the program for implementing the various control modules stored in the ROM 402 into the RAM 403 and executing it. Some or all of functions in steps of FIG. 15 may be implemented by hardware such as an ASIC or electronic circuit. Sign “S” in description of each process indicates a step in this flowchart.

The processing presented in FIG. 15 is started in response to an input of a test pattern print start instruction by the user to the printing apparatus.

In S1501, the CPU 401 causes air blowing under the first drying conditions. The first drying conditions are applied to the platen blower unit 202. Specifically, the CPU 401 sets “the air-blow setting: OFF”, “the temperature setting: OFF”, and “the airflow speed setting: OFF” in the platen blower unit 202 as presented in FIG. 10. In short, the platen blower unit 202 will be kept from supplying air. In S1502, the CPU 401 prints the test patterns under the first drying conditions. Specifically, the CPU 401 causes the print head 105 to print the test patterns while keeping the platen blower unit 202 from supplying the air. In S1503, the CPU 401 conveys the print medium to the fixation unit 203 for the purpose of drying and fixing the printed images of the test patterns and thus fixes the images. In S1504, the CPU 401 makes a notification that the printing on the print medium is completed after the end of the fixation in S1503. This notification may be made by the display section 442. Instead, the notification may be made by the display of the host apparatus 404. Alternatively, the notification may be issued to a smartphone or the like owned by the user. In S1505, the CPU 401 determines whether or not a user's input is received. The user's input herein is supposed to be an input informing whether or not there is an image without any image defect. The CPU 401 proceeds to the process in S1506 from the process in S1505 if determining that the user's input is received. On the other hand, the CPU 401 continues the process in S1505 if determining that the user's input is not received yet.

In S1506, the CPU 401 determines whether or not there is an image without any image defect from the print results of the test patterns in FIG. 12 based on the information in the user's input in S1505. The CPU 401 proceeds to the process in S1507 from the process in S1506 if determining that there is an image without any image defect from the print results of the test patterns in FIG. 12. In this case, on the print medium with the test patterns printed thereon, the colored ink spreads in the cases of the reaction liquid volumes of 0 [pl] and 5 [pl], while the colored ink does not spread in the cases of the reaction liquid volumes of 10 [pl], 15 [pl], and 20 [pl] as presented in FIG. 12. This is just an example and corresponds to the case of the print medium having a hardly wettable property presented in FIG. 12. Specifically, the user can visually determine that the images (c), (d), and (e) in FIG. 12 are images without any image defect among the images (a) to (e) in FIG. 12. Therefore, the user inputs a choice “Yes” from the user interface provided in the printing apparatus main body or the host apparatus 404. Oh the other hand, the CPU 401 proceeds to the process in S1509 from the process in S1506 if determining that there is no image without any image defect from the print results of the test patterns in FIG. 13. In this case, on the print medium with the test patterns printed thereon, the colored ink spreads in all the cases of the reaction liquid volumes of 0 [pl] to 20 [pl] as presented in FIG. 13. This is just an example and corresponds to the case of the print medium having an easily wettable property as presented in FIG. 13. Specifically, the user can visually determine that there is no image without any image defect among the images (a) to (e) in FIG. 13. Therefore, the user inputs a choice “No” from the user interface provided in the printing apparatus main body or the host apparatus 404.

In S1507, the CPU 401 sets the drying conditions to the first drying conditions in FIG. 10 and proceeds to the process in S1508 from the process in S1507. Specifically, the CPU 401 automatically sets the drying conditions based on the first drying conditions of “the air-blow setting: OFF”, “the temperature setting: OFF”, and “the airflow speed setting: OFF”. Instead, if the first drying conditions are input by the user from the user interface provided in the printing apparatus main body or the host apparatus 404, the CPU 401 performs the following process. Specifically, in the printing apparatus main body or the host apparatus 404, the CPU 401 sets the drying conditions based on the input first drying conditions. Through this operation, the air supply based on the first drying conditions is set in the platen blower unit 202. In other words, the first drying conditions including the air-blow setting of keeping the platen blower unit 202 from supplying the air are set.

In S1508, the CPU 401 sets, as an ejection reaction liquid volume, the reaction liquid volume (c) that is the smallest liquid volume among the reaction liquid volumes in the images (c), (d), and (e) without any image defect in FIG. 12. The setting method may be achieved based on information on the reaction liquid volumes contained in a user's input from the user interface provided in the printing apparatus main body or the host apparatus 404. In the printing apparatus main body or the host apparatus 404, the CPU 401 sets the ejection reaction liquid volume based on the input information on the reaction liquid volumes. Through the operations prescribed in the flowchart described above, the drying conditions and the reaction liquid volume for printing on the print medium having a hardly wettable property are determined.

According to the above-described flowchart in FIG. 15, after the test pattern printing under the first drying conditions in S1502, the process of determining whether or not there is an image without any image defect in S1506 is performed. Thus, if there is an image without any image defect in the determination in S1506, the CPU 401 can determine the drying conditions and the reaction liquid volume without causing the test patterns to be printed under the second drying conditions. Therefore, the effective processing can be achieved.

In S1509, the CPU 401 causes air blowing under the second drying conditions. The second drying conditions are applied to the platen blower unit 202. Specifically, the CPU 401 sets “the air-blow setting: ON”, “the temperature setting: 30° C.”, and “the airflow speed setting: 3 m/s” in the platen blower unit 202 as presented in FIG. 10. In short, the platen blower unit 202 will supply air. In particular, the platen blower unit 202 will supply heated air. In S1510, the CPU 401 prints the test patterns under the second drying conditions. Specifically, the CPU 401 causes the print head 105 to print the test patterns while causing the platen blower unit 202 to supply the heated air. In S1511, the CPU 401 conveys the print medium to the fixation unit 203 for the purpose of drying and fixing the printed images for the test patterns and thus fixes the images. In S1512, the CPU 401 makes a notification that the printing on the print medium is completed after the end of the fixation in S1511. This notification may be made in the same manner as in S1504.

In S1513, the CPU 401 sets the drying conditions to the second drying conditions in FIG. 10 and proceeds to the process in S1514 from the process in S1513. Specifically, the CPU 401 automatically sets the drying conditions based on the second drying conditions of “the air-blow setting: ON”, “the temperature setting: 30° C.”, and “the airflow speed setting: 3 m/s”. Instead, if the second drying conditions are input by the user from the user interface provided in the printing apparatus main body or the host apparatus 404, the CPU 401 performs the following process. Specifically, in the printing apparatus main body or the host apparatus 404, the CPU 401 sets the drying conditions based on the input second drying conditions. Through this operation, the air supply based on the second drying conditions is set in the platen blower unit 202. In other words, the second drying conditions including the air-blow setting of causing the platen blower unit 202 to supply air are set.

In S1514, the CPU 401 sets, as the ejection reaction liquid volume, the reaction liquid volume (d) that is the smaller liquid volume between the reaction liquid volumes in the images (d) and (e) without any image defect in FIG. 14. The setting method may be achieved based on information on the reaction liquid volumes in a user's input from the user interface provided in the printing apparatus main body or the host apparatus 404. In the printing apparatus main body or the host apparatus 404, the CPU 401 sets the ejection reaction liquid volume based on the input information on the reaction liquid volumes. Through the operations prescribed in the flowchart described above, the drying conditions and the reaction liquid volume for printing on the print medium having an easily wettable property are determined.

According to the above-described flowchart in FIG. 15, if there is no image without any image defect in the determination in S1506, the CPU 401 causes the test patterns to be printed under the second drying conditions and can determine the drying conditions and the reaction liquid volume based on the test patterns. The test patterns are printed under the second drying conditions to which the drying conditions are changed from the first drying conditions. According to the above, if there is no image without any image defect under the first drying conditions, the test patterns can be printed again. In this operation, the test pattern printing under the second drying conditions involving heating air is performed only if necessary, so that power required to heat the air is not wastefully consumed.

Moreover, the platen blower unit 202 blows the heated air to the surface of the print medium having an easily wettable property during printing. This operation promotes evaporation of the moisture contained in the ink and facilitates the fixation of the ink, and thereby may make it possible to prevent an image defect due to an ink spreading phenomenon. In addition, the smallest liquid volume is determined as the reaction liquid volume for preventing an image defect, which may make it possible to reduce a wasteful consumption of the reaction liquid volume.

For a print medium having a hardly wettable property, the platen blower unit 202 does not blow the heated air to the surface of the print medium during printing, which may make it possible to prevent an image defect due to the occurrence of a streaky unevenness phenomenon that may occur due to accelerated drying. Specifically, since a print medium having a hardly wettable property has a large contact angle θ as illustrated in FIG. 8C, a droplet of an ink tends not to spread along the surface of the print medium. Here, the ink is assumed to be a colored ink mixed with the reaction liquid ink. In the case where the heated air is blown in the state of FIG. 8C, the moisture in the droplet of the ink evaporates while the droplet of the ink is kept from spreading over the surface of the print medium. Along with the evaporation of the moisture in the droplet of the ink, the ratio of synthetic resin particles in the reaction liquid to the moisture in the droplet of the ink increases. For this reason, the droplet of the ink starts forming a film on its surface without spreading over the surface of the print medium. Simultaneously, a part of the blown air passes along the surface of the droplet and forms a streak. As a result, as viewed as a whole, the multiple droplets of the ink in the film form are scattered on the print medium, resulting in an uneven state as a whole. This results in the occurrence of a streaky unevenness phenomenon. To address this, in the processing according to the flowchart of FIG. 15, the air blowing control under the first drying conditions is performed first. In other words, the platen blower unit 202 is kept from blowing the heated air to the platen 104. Through this operation, even if a print medium has a hardly wettable property, the occurrence of a streaky unevenness phenomenon can be avoided, so that an image defect due to a streaky unevenness phenomenon can be prevented. Meanwhile, even though a print medium has an easily wettable property and there is no image without spreading of the colored ink under the first drying conditions, the air blowing control under the second drying conditions is performed. This also makes it possible to print an image without spreading of the colored ink even on a print medium having an easily wettable property, so that an image defect due to an ink spreading phenomenon can be also prevented on a print medium having an easily wettable property. As a result, it is possible to obtain high-quality images.

Here, there is a possibility that there is no image without any image defect on the print medium even in S1512. In this case, the air may be blown under the third drying conditions that are more powerful for drying than the second drying conditions. For example, the third drying conditions may be set with the air-blow setting of “ON”, the temperature setting of “35° C.”, and the airflow speed setting of “6 m/s”. The CPU 401 causes the air blowing under the third drying conditions. The third drying conditions are applied to the platen blower unit 202. The CPU 401 prints the test patterns under the third drying conditions. The CPU 401 conveys the print medium to the fixation unit 203 for the purpose of drying and fixing the printed images for the test patterns and thus fixes the images. In this case, the third drying conditions are set instead of the second drying conditions. The reaction liquid volume is determined from the test patterns under the third drying conditions.

(First Modification: Automatic Determination through Similarity Calculation)

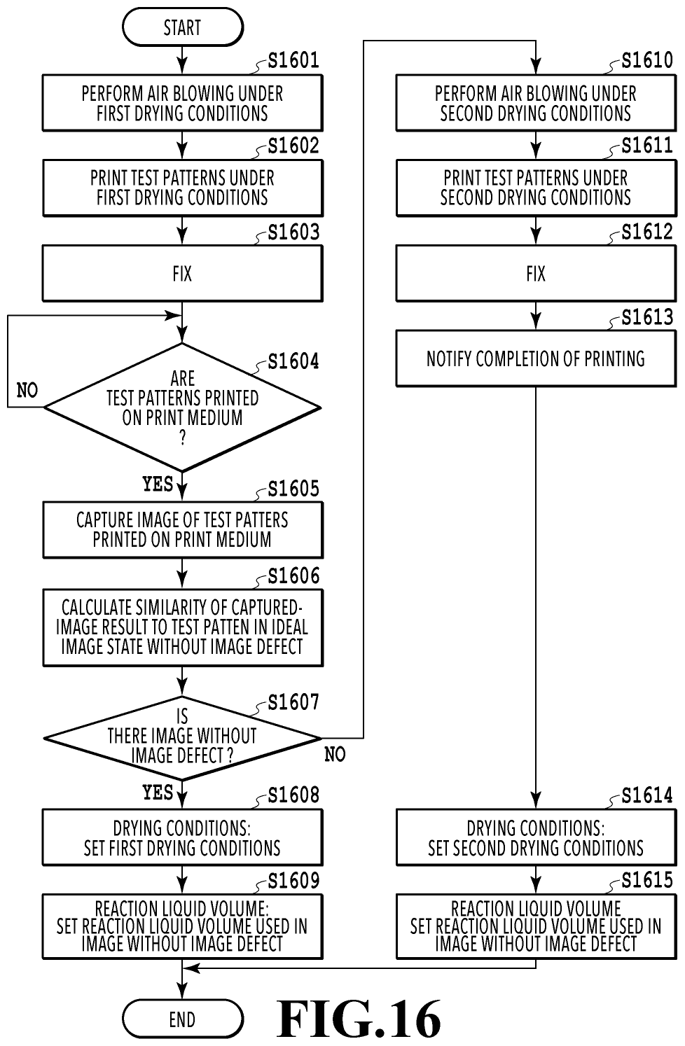

FIG. 16 is a flowchart presenting a first modification of the processing for determining the drying conditions and the reaction liquid volume for printing according to the first embodiment of the present disclosure. The processing presented in FIG. 16 is implemented by the CPU 401 reading out the program for implementing the various control modules stored in the ROM 402 into the RAM 403 and executing it. Some or all of functions in steps of FIG. 16 may be implemented by hardware such as an ASIC or electronic circuit. Sign “S” in description of each process indicates a step in this flowchart.

The processing presented in FIG. 16 is started in response to an input of a test pattern print start instruction by the user to the printing apparatus.

The processing presented in FIG. 16 is for a case where the determination concerning test patterns printed on a print medium is automatically made by pattern matching. The processes in S1601 to S1603 and S1607 to S1615 of FIG. 16 are the same as the processes in S1501 to S1503 and S1506 to S1514 of FIG. 15. Therefore, the description thereof is omitted herein.

In S1604, the CPU 401 determines whether or not the test patterns are printed on the print medium. If determining that the test patterns are printed, the CPU 401 proceeds to the process in S1605 from the process in S1604. On the other hand, if determining that the test patterns are not printed, the CPU 401 continues the process in S1604. In order to make the determination in S1604, the reflective optical sensor 107 just has to be arranged downstream of the fixation unit 203. As described above, the reflective optical sensor 107 is capable of detecting the density of the patterns printed on the print medium P as the optical reflectance. Thus, it is possible to determine whether or not the patterns are printed on the print medium based on the density of the patterns. In S1605, the CPU 401 causes the image capture section 441 to capture an image of the test patterns printed on the print medium. This operation makes the test patterns usable as captured-image data, so that the captured-image data can be used in pattern matching to be described below. In S1606, the CPU 401 calculates the similarity of each of the captured-image results to a test pattern in an ideal image state having no image defect. Specifically, the CPU 401 causes the test pattern in the ideal image state having no image defect to be stored as ideal data in advance. This makes it possible to calculate the similarity of the captured-image data to the ideal data. The similarity may be calculated by using a certain pattern matching algorithm. For example, the similarity of the pixel values of the captured-image data to the pixel values of the ideal data as a template image may be calculated by using Sum of Squared Difference (SSD). Instead, a difference between the features of the ideal data and the features of the captured-image data may be calculated by using Scale-Invariant Feature Transform (SIFT). By adding the processes in S1604 to S1606 as described above, it is possible to automatically determine whether or not there is an image without any image defect, without the user having to visually check.

### (Second Modification: Automatic Determination by Machine Learning Model)

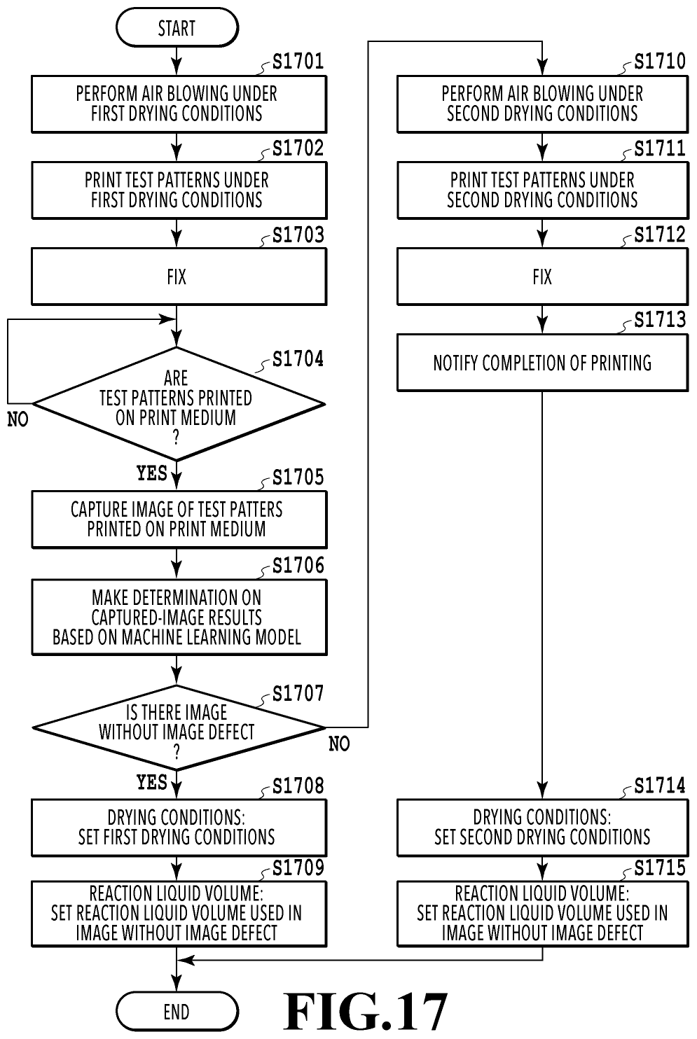

FIG. 17 is a flowchart presenting a second modification of the processing for determining the drying conditions and the reaction liquid volume for printing according to the first embodiment of the present disclosure. The processing presented in FIG. 17 is implemented by the CPU 401 reading out the program for implementing the control modules stored in the ROM 402 into the RAM 403 and executing it. Some or all of functions in steps of FIG. 17 may be implemented by hardware such as an ASIC or electronic circuit. Sign “S” in description of each process indicates a step in this flowchart.

The processing presented in FIG. 17 is started in response to an input of a test pattern print start instruction by the user to the printing apparatus.

The processing presented in FIG. 17 is for a case where the determination concerning test patterns printed on a print medium is automatically made based on a machine learning model. The processes in S1701 to S1703 and S1707 to S1715 of FIG. 17 are the same as the processes in S1501 to S1503 and S1506 to S1514 of FIG. 15. In addition, the processes in S1704 and S1705 of FIG. 17 are the same as the processes in S1604 and S1605 of FIG. 16. Therefore, the description thereof is omitted herein.

In S1706, the CPU 401 makes a determination concerning the captured-image results based on the machine learning model. Specifically, the machine learning model just has to be trained in advance by using multiple anticipated test patterns, and compare the captured-image data with the learning data thus obtained. Any learning data thus obtained can be used. More specifically, in the case where a support vector machine is used as a learning algorithm, a hyperplane may be obtained. For example, a hyperplane is obtained in advance for distinguishing between a distribution of pixel values with colored ink spreading beyond a border and a distribution of pixel values without colored ink spreading beyond the border. Whether or not there is an image defect may be determined depending on whether a distribution of pixel values included in the captured-image information can be classified into the distribution of pixel values with colored ink spreading and the distribution of pixel values without colored ink spreading by using the hyperplane as the border. The learning algorithm may be another known algorithm such, for example, as a neural network or deep learning. In addition, since it is necessary to determine whether or not there is bleeding of an image, it is preferable to create the learning data by emphasizing the profile of each object, extracting the region of the object, and doing the like as needed. By adding the processes in S1704 to S1706 as described above, it is possible to automatically determine whether or not there is an image without any image defect, without the user having to visually check.

### Second Embodiment

In a second embodiment of the present disclosure, description will be given of processing for printing test patterns while changing the drying conditions for the platen blower unit 202 and determining optimum drying conditions and an optimum reaction liquid volume from the printed images. In the first embodiment, after the test pattern printing under the first drying conditions, if there is no image without any image defect, the test pattern printing under the second drying conditions is performed. The second embodiment is different from the first embodiment in that, after the test pattern printing under the first drying conditions, the processing includes performing the test pattern printing under the second drying conditions without determining whether or not there is an image without any image defect, and then determining whether or not there is an image without any image defect. The description of the same matters as in the first embodiment is omitted herein.

### (Operation Example)

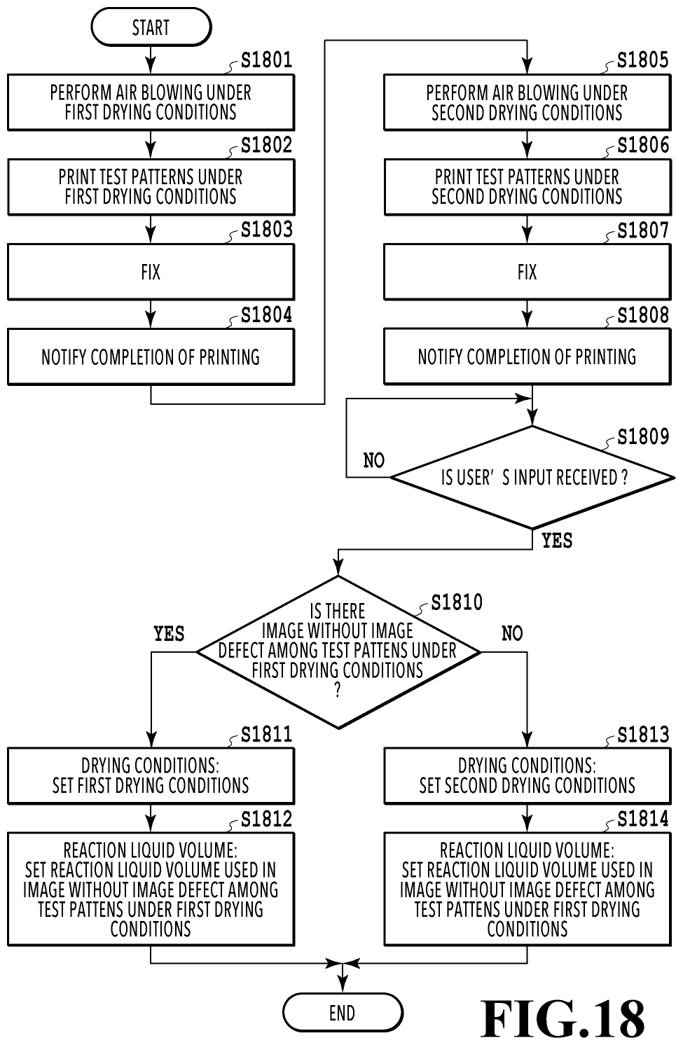

FIG. 18 is a flowchart presenting processing for determining the drying conditions and the reaction liquid volume according to the second embodiment of the present disclosure. The processing presented in FIG. 18 is implemented by the CPU 401 reading out the program for implementing the various control modules stored in the ROM 402 into the RAM 403 and executing it. Some or all of functions in steps of FIG. 18 may be implemented by hardware such as an ASIC or electronic circuit. Sign “S” in description of each process indicates a step in this flowchart.

The processing presented in FIG. 18 is started in response to an input of a test pattern print start instruction by the user to the printing apparatus.

The flowchart in FIG. 18 contains the same processes as the processes contained in the flowchart in FIG. 15, but the sequence of the processes, that is, the order of the processes is partially different. Specifically, the processes in S1801 to S1804 of FIG. 18 are the same as the processes in S1501 to S1504 of FIG. 15. The processes in S1805 to S1808 of FIG. 18 are the same as the processes in S1509 to S1512 of FIG. 15. The processes in S1809 and S1810 of FIG. 18 are the same as the processes in S1505 and S1506 of FIG. 15. Although S1810 and S1506 are differently described, but they actually contain the same process. The processes in S1811 and S1812 of FIG. 18 are the same as the processes in S1507 and S1508 of FIG. 15. The processes in S1813 and S1814 of FIG. 18 are the same as the processes in S1513 and S1514 of FIG. 15.

In other words, in the processing presented in FIG. 18, the test pattern printing under the first drying conditions is performed on a print medium and then subsequently the test pattern printing under the second drying conditions is performed on a print medium. After that, for the test patterns printed under the first drying conditions, whether or not there is an image without any image defect is determined. According to this operation, the test pattern printing under the first drying conditions and the test pattern printing under the second drying conditions can be performed consecutively. Thus, even if there is no image without any image defect for the test patterns under the first drying conditions, the test patterns under the second drying conditions are already printed on the print medium. Thus, the test patterns under the second drying conditions can be selected. Meanwhile, even if there is an image without any image defect for the test patterns under the first drying conditions, the test patterns under the second drying conditions are already printed on the print medium. However, there is an advantage in that the processing can be executed without changing the general sequence of the test pattern printing, the test pattern determination, and the setting of the drying conditions.

As described above, in the present embodiment, the test pattern printing under the first drying conditions and the test pattern printing under the second drying conditions can be performed consecutively. After that, for a print medium having a hardly wettable property, the drying conditions and the reaction liquid volume for preventing an image defect are determined based on the print results of the test patterns under the first drying conditions. Then, for a print medium having an easily wettable property, the drying conditions and the reaction liquid volume for preventing an image defect may be determined based on the print results of the test patterns under the second drying conditions.

In the second embodiment, the test pattern printing under the second drying conditions is always performed as described above. As a result, for a print medium having an easily wettable property, the dryer unit blows the heated air to the surface of the print medium during printing. This operation may make it possible to promote the evaporation of the moisture contained in the ink and facilitate the fixation of the ink. In addition, it may be also possible to prevent an image defect due to an ink spreading phenomenon. In addition, the smallest liquid volume is determined as the reaction liquid volume for preventing an image defect, which may make it possible to reduce a wasteful consumption of the reaction liquid volume. In the second embodiment, the test pattern printing under the first drying conditions and the test pattern printing under the second drying conditions are performed separately. For this reason, even on a print medium having a hardly wettable property, the test patterns are printed under the first drying conditions and the processing not involving blowing heated air to the surface of the print medium by the dryer unit during printing is also performed. This may make it possible to set the drying conditions and the reaction liquid volume suitable for preventing an image defect due to the occurrence of a streaky unevenness phenomenon that may occur due to accelerated drying.

### Third Embodiment

In the first and second embodiments of the present disclosure, the description is given of the processing for determining the reaction liquid volume for preventing a phenomenon of spreading of a single colored ink on a print medium. In a third embodiment of the present disclosure, description will be given of processing for determining the reaction liquid volume for preventing a phenomenon of spreading of a single colored ink over a print medium and further preventing a bleeding phenomenon that may occur between different colored inks. In the third embodiment, the description of the same matters as in the first and second embodiments will be omitted.

### (Test Patterns)

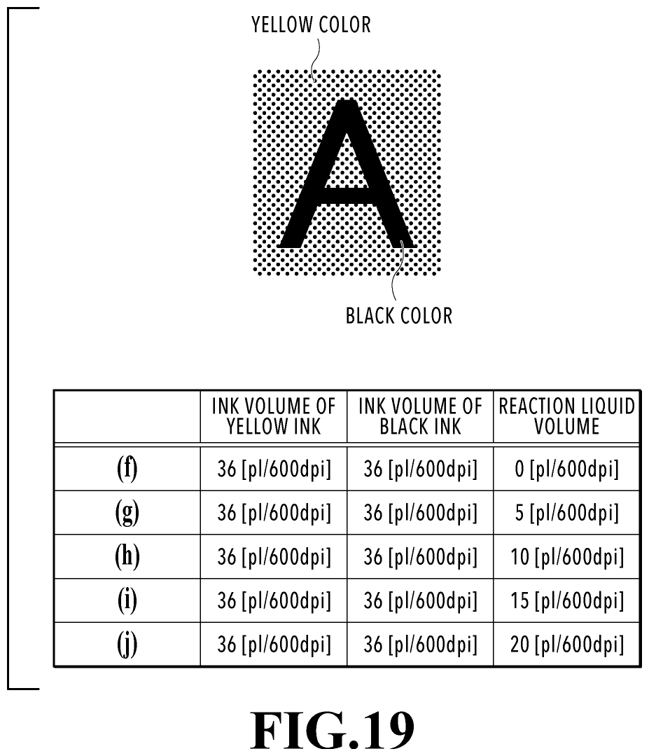

FIG. 19 is a diagram for explaining test patterns. FIG. 19 illustrates an example an image to be printed on a print medium with ejection of the reaction liquid, the image synthesized by overlaying an alphabet letter image “A” for a second colored ink on a background image for a first colored ink. For example, the yellow ink is used as the first colored ink. For example, the black ink is used as the second colored ink. For both of the yellow ink and the black ink, an ink volume per unit area is a predetermined volume of 36 [pl/600 dpi]. On the other hand, as the reaction liquid volume, five levels of liquid volumes (f) to (j) are tried as test patterns. The reaction liquid volumes per unit area (f) to (j) are 0 [pl/600 dpi], 5 [pl/600 dpi], 10 [pl/600 dpi], 15 [pl/600 dpi], and 20 [pl/600 dpi], respectively. Specifically, using each of the five levels of reaction liquid volumes (f) to (j) in FIG. 19, the test pattern is printed by using the mask patterns for the reaction liquid in FIG. 6B under the multi-pass printing control in FIG. 5. Since FIGS. 6B and 6D are the same as described above, the mask patterns in FIG. 6D may be used as the mask patterns for the reaction liquid.

### (Outline of Operations)

As a flowchart for explaining processing for determining the drying conditions and the reaction liquid volume for printing in the present embodiment, FIG. 15 in the first embodiment and FIG. 18 in the second embodiment are used. The first colored ink is not limited to the yellow ink. For example, the first colored ink may be the magenta ink. The second colored ink is also not limited to the black ink. For example, the second colored ink may be the cyan ink.

### (Without Air Blowing (First Drying Conditions); Hardly Wettable (Low Wettability))

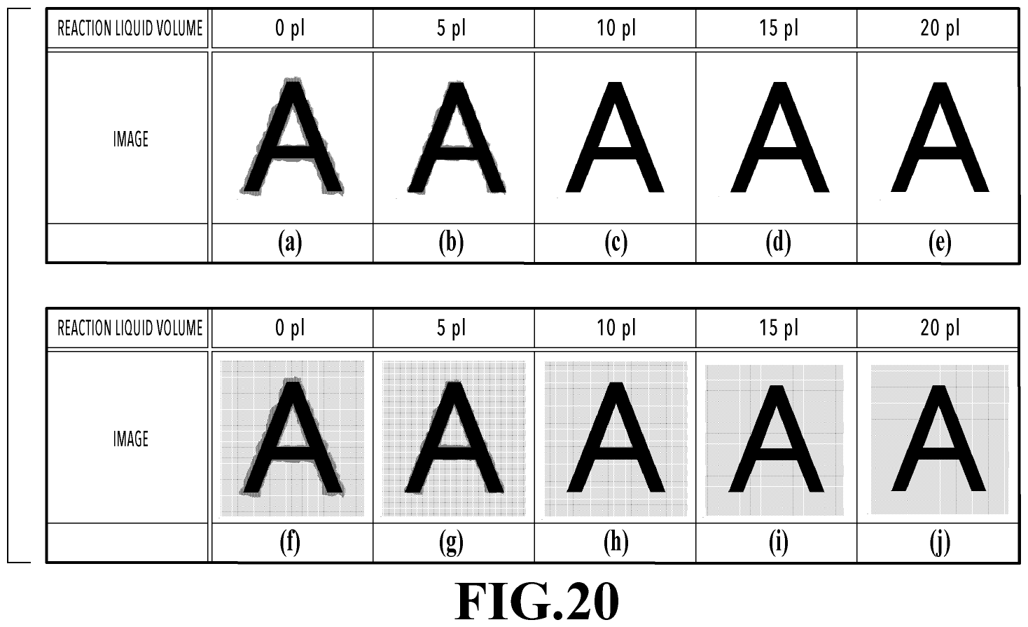

FIG. 20 is a diagram presenting print results of the test patterns on a print medium having a hardly wettable property under the first drying conditions. Specifically, FIG. 20 presents the results of printing the test patterns in FIGS. 11 and 19 on the print medium having a hardly wettable property illustrated in FIG. 8C under the first drying conditions in FIG. 10. The images (a) to (e) in FIG. 20 present the same results as in (a) to (e) in FIG. 12. The images (f) to (j) in FIG. 20 present print results of the test patterns in FIG. 19 newly added in the present embodiment. The images (c) to (e) in FIG. 20 are images without the occurrence of the ink spreading phenomena. The images (h) to (j) in FIG. 20 are images without the occurrence of the bleeding phenomena between the different colored inks. That is, the images (h) to (j) in FIG. 20 are the images where there is no bleeding between a colored ink containing a colorant and another colored ink containing another colorant different from the foregoing colorant.

### (Operation Example)

Description will be given of a case where the flowchart in the first embodiment (the processing presented in FIG. 15) is used. In S1506 of FIG. 15, the CPU 401 determines that there is an image without any image defect. The CPU 401 proceeds to the process in S1507 from the process in S1506. In S1507, the CPU 401 sets the first drying conditions as the drying conditions. Specifically, the CPU 401 sets “the air-blow setting: OFF”, “the temperature setting: OFF”, and “the airflow speed setting: OFF” as the drying conditions. In S1508, the CPU 401 selects (c) to (e) in FIG. 20 and (h) to (j) in FIG. 20 as the images without any image defect. Next, the CPU 401 sets, as the ejection reaction liquid volume, the reaction liquid volume (c) and (h) that is the smallest liquid volume among the reaction liquid volumes in the images without any image defect for both types of the test patterns (c) to (e) in FIG. 20 and the test patterns (h) to (j) in FIG. 20. The CPU 401 sets the information on the ejection reaction liquid volume based on the information in the user's input from the user interface provided in the printing apparatus main body or the host apparatus 404.

### (Operation Example)

Description will be given of a case where the flowchart in the second embodiment (the processing presented in FIG. 18) is used. In S1810 in FIG. 18, the CPU 401 determines that there is an image without any image defect. The CPU 401 proceeds to the process in S1811 from the process in S1810. In S1811, the CPU 401 sets the first drying conditions as the drying conditions. Specifically, the CPU 401 sets “the air-blow setting: OFF”, “the temperature setting: OFF”, and “the airflow speed setting: OFF” as the drying conditions. In S1812, the CPU 401 selects (c) to (e) in FIG. 20 and (h) to (j) in FIG. 20 as the images without any image defect. Next, the CPU 401 sets, as the ejection reaction liquid volume, the reaction liquid volume (c) and (h) that is the smallest liquid volume among the reaction liquid volumes in the images without any image defect for both types of the test patterns (c) to (e) in FIG. 20 and the test patterns (h) to (j) in FIG. 20. The CPU 401 sets the information on the ejection reaction liquid volume based on the information contained in the user's input from the user interface provided in the printing apparatus main body or the host apparatus 404.

### (Without Air Blowing (First Drying Conditions); Easily Wettable (High Wettability))

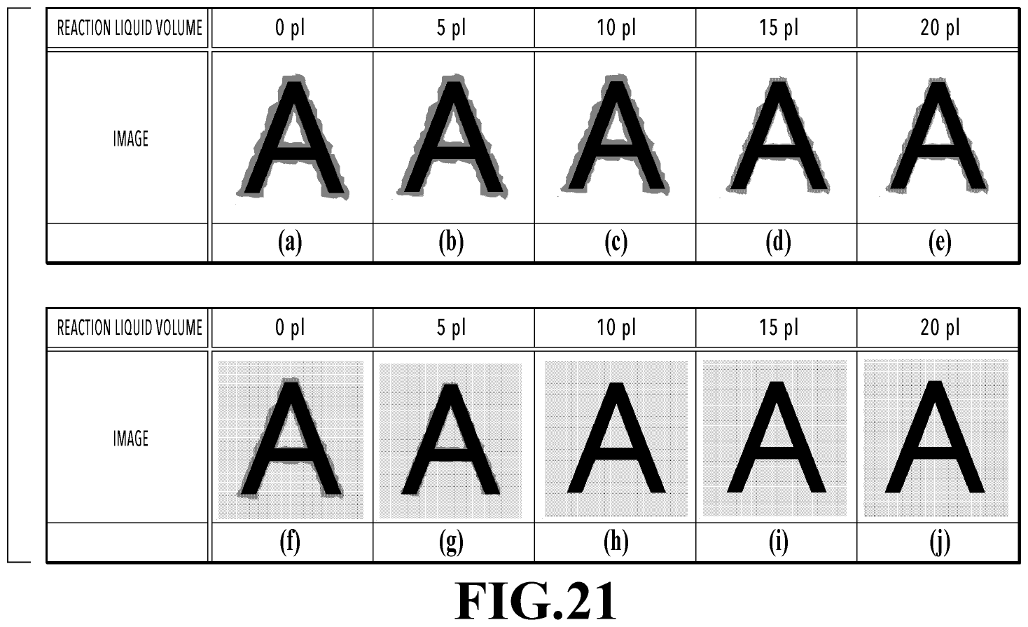

FIG. 21 is a diagram illustrating print results of the test patters on a print medium having an easily wettable property under the first drying conditions. Specifically, FIG. 21 presents the results of printing the test patterns in FIGS. 11 and 19 on the print media having an easily wettable property illustrated in FIG. 8B under the first drying conditions in FIG. 10. The images (a) to (e) in FIG. 21 present the same results as in (a) to (e) in FIG. 13. The images (f) to (j) in FIG. 21 present the results of printing the test patterns in FIG. 19 newly added in the present embodiment. The images (a) to (e) in FIG. 21 include no image without the occurrence of an ink spreading phenomenon and all are images with the occurrence of the ink spreading phenomena. The images (h) to (j) in FIG. 21 are images without the occurrence of a bleeding phenomenon between the different colored inks. That is, the images (h) to (j) in FIG. 21 are the images where there is no bleeding between a colored ink containing a colorant and another colored ink containing another colorant different from the foregoing colorant.

### (Operation Example)

Description will be given of a case where the flowchart in the first embodiment (the processing presented in FIG. 15) is used. In S1506 of FIG. 15, the CPU 401 determines that there is no image without any image defect. The CPU 401 proceeds to the process in S1509 from the process in S1506. In S1509, the CPU 401 sets the second drying conditions as the drying conditions. Specifically, the CPU 401 sets “the air-blow setting: ON”, “the temperature setting: 30° C.”, and “the airflow speed setting: 3 m/s” as the drying conditions. In S1510, the CPU 401 prints the test patterns under the second drying conditions. Specifically, the CPU 401 causes the print head 105 to print the test patterns while causing the platen blower unit 202 to supply the heated air.

### (With Air Blowing (Second Drying Conditions); Easily Wettable (High Wettability))

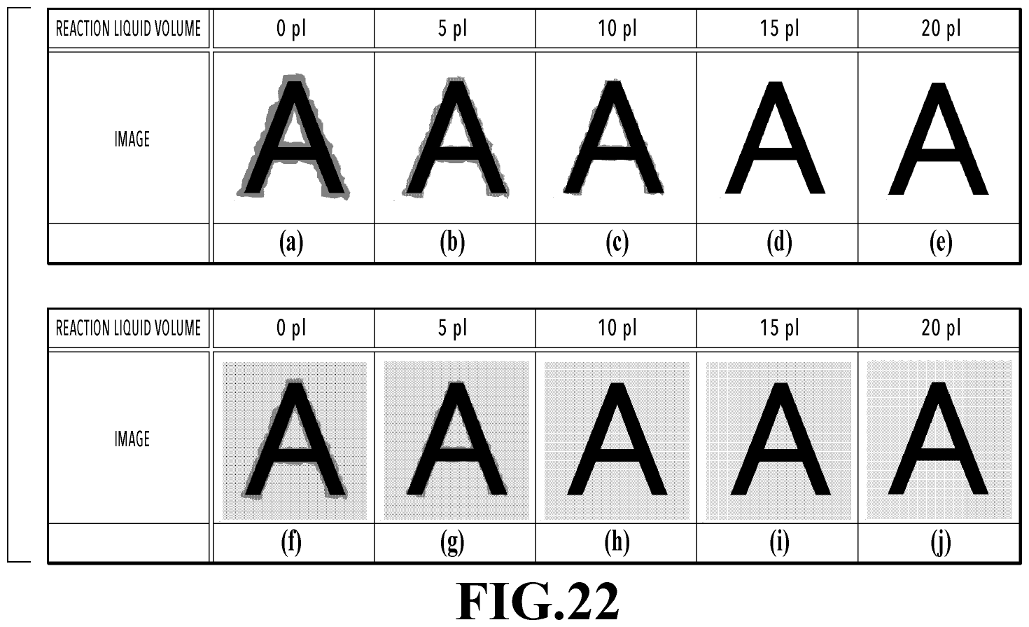

FIG. 22 is a diagram illustrating print results of the test patters on a print medium having an easily wettable property under the second drying conditions. Specifically, FIG. 22 presents the results of printing the test patterns in FIGS. 11 and 19 on a print medium having an easily wettable property illustrated in FIG. 8B under the second drying conditions in FIG. 10. The images (a) to (e) in FIG. 22 present the same results as in (a) to (e) in FIG. 14. The images (f) to (j) in FIG. 22 present the results of printing the test patterns in FIG. 19 newly added in the present embodiment. The images (d) and (e) in FIG. 22 are images without the occurrence of an ink spreading phenomenon. The images (h) to (j) in FIG. 22 are images without the occurrence of a bleeding phenomenon between the different colored inks. That is, the images (h) to (j) in FIG. 22 are the images where there is no bleeding between a colored ink containing a colorant and another colored ink containing another colorant different from the foregoing colorant.

### (Operation Example)

Description will be given of a case where the flowchart in the first embodiment (the processing presented in FIG. 15) is used. In S1513 in FIG. 15, the CPU 401 sets the second drying conditions as the drying conditions. Specifically, the CPU 401 sets “the air-blow setting: ON”, “the temperature setting: 30° C.”, and “the airflow speed setting: 3 m/s” as the drying conditions. The setting may be automatically made. Instead, the setting may be made manually from the user interface provided in the printing apparatus main body or the host apparatus 404. Next, the CPU 401 sets, as the ejection reaction liquid volume, the reaction liquid volume (d) that is the smallest liquid volume among the reaction liquid volumes in the images without any image defect for both types of the test patterns (d) and (e) in FIG. 22 and the test patterns (h) to (j) in FIG. 22. The CPU 401 sets the information on the ejection reaction liquid volume based on the information contained in the user's input from the user interface provided in the printing apparatus main body or the host apparatus 404.

### (Operation Example)

Description will be given of a case where the flowchart in the second embodiment (the processing presented in FIG. 18) is used. As presented in FIG. 21, in the case where the air blowing under the first drying conditions is performed on the print medium having an easily wettable property, there is no image without any image defect for the test patterns under the first drying conditions. Thus, in S1809, the user inputs information that there is no image without any image defect. Accordingly, in S1810, the CPU 401 determines that there is no image without any image defect. The CPU 401 proceeds to the process in S1813 from the process in S1810. In S1813, the CPU 401 sets the second drying conditions as the drying conditions. Specifically, the CPU 401 sets “the air-blow setting: ON”, “the temperature setting: 30° C.”, and “the airflow speed setting: 3 m/s” as the drying conditions. In S1814, the CPU 401 selects (d) and (e) in FIG. 22 and (h) to (j) in FIG. 22 as the images without any image defect. Next, the CPU 401 sets, as the ejection reaction liquid volume, the reaction liquid volume (d) and (i) that is the smallest liquid volume among the reaction liquid volumes in the images without any image defect for both types of the test patterns (d) and (e) in FIG. 22 and the test patterns (h) to (j) in FIG. 22. The CPU 401 sets the information on the ejection reaction liquid volume based on the information contained in the user's input from the user interface provided in the printing apparatus main body or the host apparatus 404.

In this way, it is possible to determine the drying conditions and the optimum reaction liquid volume while considering not only the ink spreading phenomenon but also the bleeding phenomenon that may occur between the different colored inks.

For a print medium having an easily wettable property, if the dryer unit operates to blow the heated air to the surface of the print medium during printing as described above, the following effects may be produced. Specifically, this operation may make it possible to promote the evaporation of the moisture contained in the inks and facilitate the fixation of the inks. Moreover, it may be possible to prevent an image defect due to an ink spreading phenomenon and additionally prevent a bleeding phenomenon that may occur between the different colored inks. In addition, since the smallest liquid volume is determined as the reaction liquid volume for preventing an image defect, it may be possible to reduce a wasteful consumption of the reaction liquid volume. On the other hand, for a print medium having a hardly wettable property, if the dryer unit is kept from blowing the heated air to the surface of the print medium during printing, the following effects may be produced. Specifically, this operation may make it possible to prevent an image defect due to the occurrence of a streaky unevenness phenomenon that may occur due to accelerated drying and additionally prevent an image defect due to a bleeding phenomenon that may occur between the different colored inks.

### OTHER EMBODIMENTS

### (Test Patterns)

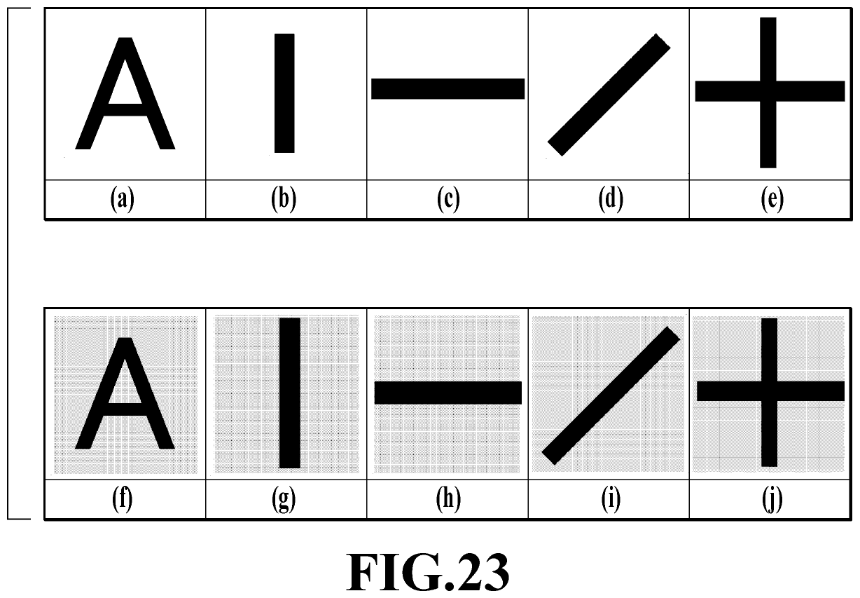

In the foregoing embodiments, the test patterns used in the first to third embodiments of the present disclosure are described as the letter “A” in black color, but the test patterns are not limited to the letter “A” and may be another letter or an image composed of a combination of elements other than a letter. FIG. 23 is a diagram for explaining other test patterns. An image (a) in FIG. 23 presents the same letter “A” as in FIG. 11, and an image (f) in FIG. 23 presents the same letter “A” as in (f) in FIG. 19. Instead of (a) in FIG. 23, images (b) to (e) each composed of a combination of elements may be used. Instead of (f) in FIG. 23, images (g) to (j) each composed of a combination of elements may be used. Alternatively, the colored ink is not limited to the black ink, and may be another colored ink or a combination of other two or more colored inks. Although the background color in FIG. 19 where the different colored inks are printed adjacent to each other is the yellow color, but is not limited to this. For example, the background color may be another colored ink or a combination of other two or more colored inks. Instead, the background color may be a light-colored ink having a large difference in brightness from an image composed of a combination of elements. In addition, the ink volume of the colored ink for the test patterns is described as the predetermined ink volume per unit area of 36 [pl/600 dpi], but is not limited to this ink volume and may be an ink volume corresponding to an ink volume designated by the user. Moreover, the reaction liquid volume per unit area is not limited to the five levels at 5 [pl/600 dpi] intervals: 0 [pl/600 dpi], 5 [pl/600 dpi], 10 [pl/600 dpi], 15 [pl/600 dpi], and 20 [pl/600 dpi]. The levels of the reaction liquid volume per unit may be also set at smaller intervals. For example, the interval may be 0.5 [pl/600 dpi]. The number of levels may be further increased to 10. In addition, an image for the reaction liquid to accompany an image for the colored ink may be an image extending from the border of an area to be printed with the colored ink to an area not to be printed with the colored ink by several pixels at 600 dpi. The test patterns described in the first to third embodiments of the present disclosure are as follows. Specifically, in the first embodiment, the case is described in which the ink spreading phenomenon occurs beyond the border between the area printed with the colored ink and the area not printed with the colored ink. In the second embodiment, the case is described in which the bleeding phenomenon occurs at the boundary between the adjacent different colored inks. In addition, the description is given of the case where the optimum reaction liquid volume is determined for preventing the ink spreading phenomenon beyond the boundary and the ink spreading phenomenon at the boundary between the adjacent different colored inks. However, the test patterns are not limited to these. Moreover, a test pattern may contain multiple images to which different reaction liquid volumes are to be applied, which makes it possible to determine whether or not there is an image defect that occurs depending on the reaction liquid volume, like images for determining the reaction liquid volume optimum to achieve uniformity (also known as graininess). Instead, to cope with all these types of image defect phenomena, the reaction liquid volumes with which none of the image defects did not occur may be selected and then the smallest reaction liquid volume may be determined among the above-selected liquid volumes.

In the drying conditions for the platen blower unit 202 during printing described in the first to third embodiments, the second drying conditions are set with air blowing at the air temperature of 30° C. and the airflow speed of 3 m/see, but are not limited to these. The drying conditions may include multiple sets of drying conditions different in the air temperature and airflow speed. After S1808 in the flowchart described in reference to FIG. 18, the test patterns may be printed multiple times under different sets of drying conditions other than the first drying conditions and the second drying conditions, and the optimum drying conditions may be determined among the drying conditions with air blowing.

In the foregoing embodiments, the example in which the dryer unit includes the fan 202A and the heater 202B is described, but the dryer unit is not limited to this. The dryer unit may include a heat exchanger. Instead, the dryer unit may include a dehumidifier.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-205142, filed Dec. 5, 2023, which is hereby incorporated by reference wherein in its entirety.

What is claimed is:

1. An inkjet printing apparatus comprising:
a print head configured to print an image by ejecting, onto a print medium, a colored ink containing a colorant and a reaction liquid to come into contact with the colorant and coagulate the colorant;
a printer unit configured to cause the print head to print a plurality of test patterns composed of a plurality of first pattern images and a plurality of accompanying second pattern images on the print medium by correspondingly printing the first pattern images with a predetermined volume of the colored ink and the second pattern images with respectively different volumes of the reaction liquid;
a dryer unit configured to dry the plurality of test patterns on the print medium during printing of the plurality of test patterns on the print medium under control of the printer unit;
an obtaining unit configured to obtain print information corresponding to print results of the plurality of respective test patterns; and
a determination unit configured to determine a volume of the reaction liquid and a drying condition for the dryer unit for printing on the print medium based on the print information obtained by the obtaining unit.

2. The inkjet printing apparatus according to claim 1, wherein
in a case where the determination unit determines based on the print information that one or more first pattern images without spreading of the colored ink from an area printed with the colored ink beyond a border between the area printed with the colored ink and an area not printed with the colored ink are present among the first pattern images of the respective test patterns, the determination unit determines, as an ejection liquid volume of the reaction liquid to be ejected by the print head, the smallest volume among the volumes of the reaction liquid for the second pattern images accompanying the above-determined first pattern images.

3. The inkjet printing apparatus according to claim 2, wherein
the dryer unit includes a blower capable of controlling an airflow rate of air to be supplied to the print medium,
the drying condition includes a first drying condition and a second drying condition,
the first drying condition includes an air-blow setting of causing control to keep the blower from supplying the air,
the second drying condition includes an air-blow setting of causing control to cause the blower to supply the air,
in a case where the determination unit determines based on the print information that one or more first pattern images without spreading of the colored ink beyond the border are present among the first pattern images, the determination unit causes the plurality of test patterns to be printed with drying by the dryer unit under the first drying condition, and
in a case where the determination unit determines that no first pattern image without spreading of the colored ink beyond the border is present among the first pattern images, the determination unit causes the plurality of test patterns to be printed with drying by the dryer unit under the second drying condition.

4. The inkjet printing apparatus according to claim 3, wherein
the dryer unit further includes a temperature adjuster capable of adjusting a temperature of the air to be supplied to the print medium.

5. The inkjet printing apparatus according to claim 4, wherein
the first drying condition further includes a temperature setting of keeping the temperature adjuster from adjusting the temperature of the air, and
the second drying condition further includes a temperature setting of causing the temperature adjuster to adjust the temperature of the air.

6. The inkjet printing apparatus according to claim 5, wherein
in a state where the dryer unit controls the blower and the temperature adjuster under the first drying condition, in a case where the determination unit determines based on the print information that one or more first pattern images without spreading of the colored ink are present among the first pattern images of the respective test patterns printed under the first drying condition, the determination unit determines, as the ejection liquid volume, the smallest volume among the volumes of the reaction liquid for the second pattern images accompanying the above-determined first pattern images.

7. The inkjet printing apparatus according to claim 5, wherein
in a case where the determination unit determines based on the print information that one or more first pattern images without spreading of the colored ink are present among the first pattern images of the respective test patterns dried under the second drying condition by the dryer unit, the determination unit determines, as the ejection liquid volume, the smallest volume among the volumes of the reaction liquid for the second pattern images accompanying the above-determined first pattern images.

8. The inkjet printing apparatus according to claim 3, wherein
the determination unit determines based on the print information whether or not spreading of the colored ink occurs in each of the first pattern images of the respective test patterns dried by the dryer unit under the first drying condition.

9. The inkjet printing apparatus according to claim 3, wherein
after the plurality of test patterns are printed with drying by the dryer unit under the first drying condition as a plurality of first test patterns and a plurality of different test patterns other than the plurality of test patterns are printed with drying by the dryer unit under the second drying condition as a plurality of second test patterns, the determination unit determines, based on the print information, whether or not spreading of the colored ink occurs in each of the first pattern images of the respective first test patterns.

10. The inkjet printing apparatus according to claim 2, wherein
in a case where the determination unit determines based on the print information that one or more of the first pattern images have no spreading of the colored ink beyond the border of the area printed with the colored ink and that one or more of third pattern images have no bleeding between the colored ink and a different colored ink other than the former colored ink at a boundary between an area printed with the colored ink and an area printed with the different colored ink,
the determination unit determines, as the ejection liquid volume to be ejected by the print head, the smallest volume among the volumes of the reaction liquid for the second pattern images accompanying the first pattern images having no spreading of the colored ink and the volumes of the reaction liquid for the second pattern images accompanying the third pattern images having no bleeding between the colored ink and the different colored ink.

11. The inkjet printing apparatus according to claim 2, further comprising an input unit configured to receive an input by a user, wherein
the obtaining unit obtains, as the print information, input information based on the input by the user received by the input unit.

12. The inkjet printing apparatus according to claim 2, further comprising an image capture unit configured to capture an image of the plurality of test patterns printed on the print medium, wherein
the obtaining unit obtains, as the print information, captured-image information based on the image of the plurality of test patterns captured by the image capture unit.

13. The inkjet printing apparatus according to claim 12, wherein
in a case where the obtaining unit obtains the captured-image information as the print information, the determination unit determines whether or not spreading of the colored ink occurs based on a similarity of each of the plurality of test patterns as the print results corresponding to the print information to an ideal test pattern having no spreading of the colored ink.

14. The inkjet printing apparatus according to claim 12, wherein
in a case where the obtaining unit obtains the captured-image information as the print information, the determination unit determines whether or not spreading of the colored ink occurs based on a machine learning model trained to distinguish whether or not spreading of the colored ink occurs.

15. The inkjet printing apparatus according to claim 1, further comprising a display unit configured to display information on an image of the plurality of test patterns.

16. An inkjet printing method comprising:
a first printing step of printing an image by ejecting, onto a print medium, a colored ink containing a colorant and a reaction liquid to come into contact with the colorant and coagulate the colorant;
a second printing step of printing a plurality of test patterns composed of a plurality of first pattern images and a plurality of accompanying second pattern images onto the print medium in the first printing step, by correspondingly printing the first pattern images with a predetermined volume of the colored ink and the second pattern images with different volumes of the reaction liquid;
a drying step of drying the plurality of test patterns on the print medium during printing of the plurality of test patterns on the print medium in the second printing step;
an obtaining step of obtaining print information corresponding to print results of the plurality of respective test patterns; and
a determining step of determining a volume of the reaction liquid and a drying condition in the drying step for printing on the print medium based on the print information obtained in the obtaining step.

17. An inkjet printing system comprising
an inkjet printing apparatus configured to print an image on a print medium; and
an input unit configured to receive an input by a user, wherein
the inkjet printing apparatus includes:
a print head configured to print an image by ejecting, onto a print medium, a colored ink containing a colorant and a reaction liquid to come into contact with the colorant and coagulate the colorant;
a printer unit configured to cause the print head to print a plurality of test patterns composed of a plurality of first pattern images and a plurality of accompanying second pattern images on the print medium by correspondingly printing the first pattern images with a predetermined volume of the colored ink and the second pattern images with respectively different volumes of the reaction liquid;
a dryer unit configured to configured to dry the plurality of test patterns on the print medium during printing of the plurality of test patterns on the print medium under control of the printer unit;
an obtaining unit configured to obtain print information corresponding to print results of the plurality of respective test patterns; and
a determination unit configured to determine a volume of the reaction liquid and a drying condition for the dryer unit for printing on the print medium based on the print information obtained by the obtaining unit, and
the obtaining unit obtains, as the print information, input information based on the input by the user received by the input unit.

18. An inkjet printing system comprising
an inkjet printing apparatus configured to print an image on a print medium; and
an image capture unit configured to capture an image, wherein
the inkjet printing apparatus includes:
a print head configured to print an image by ejecting, onto a print medium, a colored ink containing a colorant and a reaction liquid to come into contact with the colorant and coagulate the colorant;
a printer unit configured to cause the print head to print a plurality of test patterns composed of a plurality of first pattern images and a plurality of accompanying second pattern images on the print medium by correspondingly printing the first pattern images with a predetermined volume of the colored ink and the second pattern images with respectively different volumes of the reaction liquid;
a dryer unit configured to configured to dry the plurality of test patterns on the print medium during printing of the plurality of test patterns on the print medium under control of the printer unit;
an obtaining unit configured to obtain print information corresponding to print results of the plurality of respective test patterns; and
a determination unit configured to determine a volume of the reaction liquid and a drying condition for the dryer unit for printing on the print medium based on the print information obtained by the obtaining unit, and
the obtaining unit obtains, as the print information, captured-image information based on an image of the plurality of test patterns captured by the image capture unit.
